(19) United States
(12) Patent Application Publication
(10) Pub. No.: US 2025/0085610 A1
(43) Pub. Date: Mar. 13, 2025

(54) ELECTRONIC APPARATUS WITH ROTATABLE FINDER

(71) Applicant: CANON KABUSHIKI KAISHA, Tokyo (JP)

(72) Inventors: TAKAZUMI SEO, Tokyo (JP); RYOHEI KANDO, Tokyo (JP)

(21) Appl. No.: 18/960,096

(22) Filed: Nov. 26, 2024

Related U.S. Application Data
(63) Continuation of application No. PCT/JP2023/021833, filed on Jun. 13, 2023.

(30) Foreign Application Priority Data
Jun. 20, 2022 (JP) 2022-098703

(51) Int. Cl. G03B 13/10; G03B 17/04

(52) U.S. Cl. CPC G03B 13/10; G03B 17/04

(57) ABSTRACT

An electronic apparatus capable of locking a finder at a position where the finder is rotated. The electronic apparatus includes an apparatus body, a finder, and a support mechanism provided in an apparatus body, supporting the finder so as to be movable between a housed stat in which the finder is housed in the apparatus body, a pulled-out state in which the finder is pulled out from the apparatus body, a rotatable state in which the finder is rotatable from the pulled-out state, and a tilt-lock state in which the finder is locked at the rotated position from the pulled-out state. A rotation shaft serving as a rotation center of the finder is located outside the apparatus body in any of the pulled-out state, the rotated state, and the tilt-lock state, and moves into the apparatus body as the finder transitions to the housed state.

### Cross-Reference to Related Applications

This application is a Continuation of International Patent Application No. PCT/JP2023/021833 filed on Jun. 13, 2023, which claims the benefit of Japanese Patent Application No. 2022-098703 filed on Jun. 20, 2022, both of which are hereby incorporated by reference herein in their entirety.

### BACKGROUND OF THE INVENTION

### Field of the Invention

The present invention relates to electronic apparatuses, and particularly to an electronic apparatus including a rotatable finder.

### Background Art

Conventionally, a camera including an electronic viewfinder (hereinafter, referred to as a finder) in which the finder is rotatable with respect to a camera body to increase a degree of freedom of a capturing posture of a user is known. An accessory shoe for attaching accessories is provided on the upper part of the finder of the electronic apparatus. For example, PTL 1 discloses a configuration of a finder built in a camera, in which the finder can be pulled out from the camera body and can be tilted by about 45 degrees with respect to the camera body from a pulled-out state.

Further, PTL 2 discloses a configuration of a support mechanism that supports a finder in a rotatable manner in the finder externally attached to an accessory shoe of a camera. A tilt lock dial is provided coaxially with a tilt shaft of the support mechanism, and the finder can be locked at a predetermined angle with respect to the camera body by tightening the tilt lock dial. This prevents the finder from moving accidentally when a user presses an eye against an eyepiece window of the finder.

### Citation List

### Patent Literature

PTL 1: Japanese Patent Publication No. 6192337

PTL 2: Japanese Patent Publication No. 6506479

In the technique disclosed in PTL 1, the tilt angle of the finder is limited to about 45 degrees, and there is no tilt lock mechanism. Therefore, when the user presses the eye against the eyepiece window of the finder, the finder may be inadvertently moved.

The technique disclosed in PTL 2 is an external finder accessory attached to the accessory shoe of the camera, and a space that can be occupied by the external finder accessory is large. Therefore, in such an external finder accessory, the tilt angle can be set to 45 degrees or more, and the tilt lock mechanism can be easily mounted. However, the external finder accessory occupies the accessory shoe and other external accessories cannot be attached to the camera, which may cause a decrease in expandability of the camera and a decrease in portability in carrying.

Further, since the tilt lock mechanism is provided with a lock operation unit on the tilt shaft of the support mechanism, when the tilt lock mechanism is applied to a built-in finder of an image capturing apparatus and the tilt shaft is accommodated in a body of the image capturing apparatus together with the finder, the body of the image capturing apparatus is increased in size in the width direction.

### SUMMARY OF THE INVENTION

The present invention provides an electronic apparatus capable of locking a finder at a position where the finder is rotated, in addition to rotating the finder pulled out from an electronic apparatus body by using a support mechanism built in the electronic apparatus body.

In order to achieve the object, an electronic apparatus of the present invention includes an apparatus body, a finder having a lens, and a support mechanism provided in an apparatus body, supporting the finder so as to be movable between a plurality of states, and having a rotation shaft serving as a rotation center of the finder. The plurality of states include a housed state in which the finder is housed in the apparatus body, a pulled-out state in which the finder is pulled out from the apparatus body, a rotatable state in which the finder is rotatable from the pulled-out state, and a tilt-lock state in which the finder is locked at the rotated position from the pulled-out state. The rotation shaft is located outside the apparatus body when the finder is in any of the pulled-out state, the rotated state, and the tilt-lock state, and moves from the outside of the apparatus body into the apparatus body as the finder transitions to the housed state.

Further features of the present invention will become apparent from the following description of exemplary embodiments with reference to the attached drawings.

### BRIEF DESCRIPTION OF THE DRAWINGS

FIG. 1A is a perspective view of a camera in accordance with a first embodiment of the present invention.

FIG. 1B is a perspective view of the camera in accordance with the first embodiment of the present invention.

FIG. 2A is a perspective view of the camera for explaining a state of a finder.

FIG. 2B is a perspective view of the camera for explaining a state of the finder.

FIG. 2C is a perspective view of the camera for explaining a state of the finder.

FIG. 3A is an exploded perspective view of a camera body.

FIG. 3B is an exploded perspective view showing a configuration for holding an accessory shoe and a finder.

FIG. 4A is an exploded perspective view of the finder.

FIG. 4B is an enlarged perspective view of a cam member.

FIG. 4C is a sectional view of an assembled state of a lens holder and a fixed barrel.

FIG. 4D is a front view of the lens holder and the fixed barrel in the assembled state.

FIG. 5A is an exploded perspective view of a support mechanism.

FIG. 5B is a view for explaining a long hole of a rectilinear tilt plate.

FIG. 6A is an exploded perspective view of the finder unit.

FIG. 6B is a top view of the finder unit.

FIG. 6C is a sectional view of the finder unit.

FIG. 6D is a partial enlarged view of a portion A in FIG. 6C.

FIG. 7A is a side view showing operational transition of the support mechanism.

FIG. 7B is a side view showing the operational transition of the support mechanism.

FIG. 7C is a side view showing the operational transition of the support mechanism.

FIG. 7D is a side view showing the operational transition of the support mechanism.

FIG. 7E is a side view showing the operational transition of the support mechanism.

FIG. 8A is a view for explaining a configuration to lock the finder.

FIG. 8B is a view for explaining the configuration to lock the finder.

FIG. 9A is a side view showing operational transition of a support mechanism in a second embodiment.

FIG. 9B is a side view showing the operational transition of the support mechanism in the second embodiment.

FIG. 9C is a side view showing the operational transition of the support mechanism in the second embodiment.

FIG. 10 is an exploded perspective view for explaining a configuration of a finder unit in a third embodiment.

FIG. 11 is an exploded perspective view for explaining a configuration of a lock lever.

FIG. 12A is an exploded perspective view of a support mechanism.

FIG. 12B is an exploded perspective view of a lock mechanism.

FIG. 12C is a perspective view of a rotation shaft.

FIG. 12D is a perspective view of a rectilinear motion shaft.

FIG. 13A is a view for explaining a configuration to lock the finder.

FIG. 13B is a view for explaining the configuration to lock the finder.

FIG. 13C is a sectional view of the support mechanism shown in FIG. 13B.

FIG. 13D is a partial enlarged view of a portion C in FIG. 13C.

FIG. 14A is a top view of the finder unit for explaining an arrangement of components of the lock mechanism in the finder unit.

FIG. 14B is a sectional view of the finder unit shown in FIG. 14A.

FIG. 14C is a sectional view of the finder unit shown in FIG. 14A.

FIG. 14D is a partial enlarged view of a portion E in FIG. 14B.

FIG. 14E is a plan view of the finder unit for explaining the arrangement of the components of the lock mechanism in the finder unit.

### DESCRIPTION OF THE EMBODIMENTS

Hereinafter, embodiments of the present invention will be described in detail with reference to the drawings. However, the configurations described in the following embodiments are merely examples, and the scope of the present invention is not limited by the configurations described in the embodiments. For example, each unit constituting the present invention can be replaced with any configuration capable of exhibiting the same function. Further, an arbitrary component may be added. Any two or more configurations (features) of the embodiments can be combined.

The present invention is not limited to a configuration in which a tilt angle can be locked in a stepwise manner, and may be applied to a configuration in which the tilt angle can be locked at an arbitrary angle. Further, as an example of the electronic apparatus of the present invention, a camera that is one of image capturing apparatuses will be described. Therefore, the scope of application of the present invention is not limited to the image capturing apparatus such as a camera, and may include any electronic device having a finder.

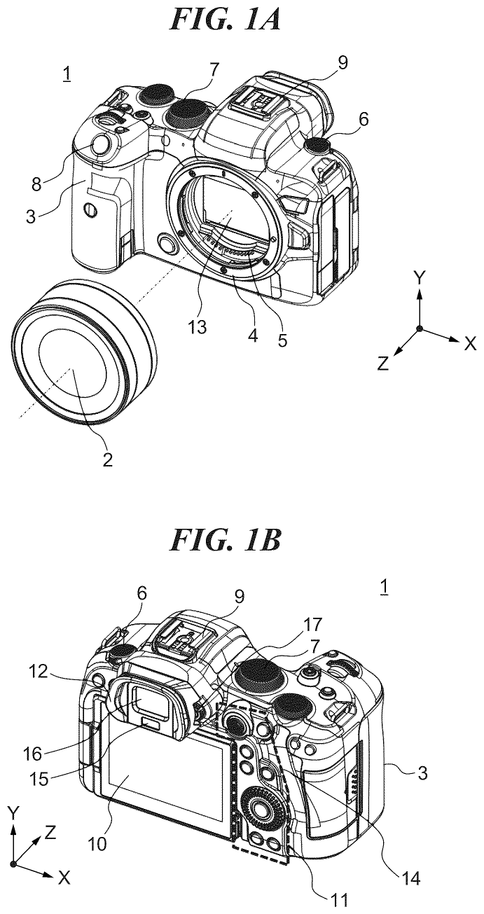

A first embodiment will now be described with reference to FIGS. 1A to 8B. In the drawings, the same members are denoted by the same reference numerals, and redundant descriptions will be omitted. FIGS. 1A and 1B are perspective views of a lens-interchangeable digital camera (hereinafter referred to as a camera) as a camera to which an interchangeable lens can be attached. FIG. 1A is a front perspective view of a camera body 1 (an apparatus body) of the camera concerning the first embodiment, and is a view showing a state in which the interchangeable lens 2 is mounted. FIG. 1B is a rear perspective view of the camera body 1.

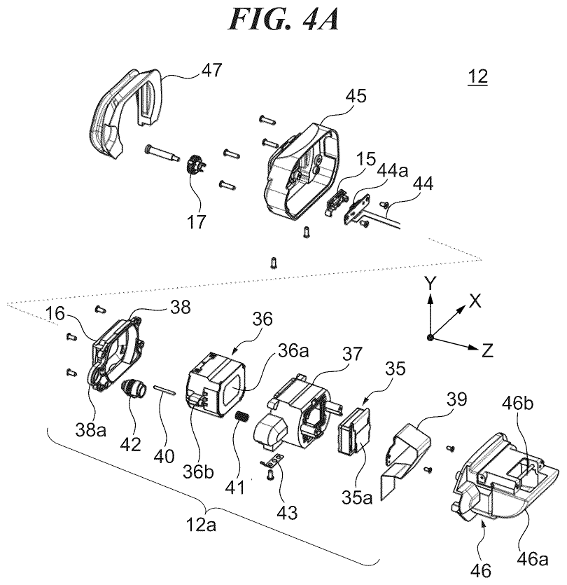

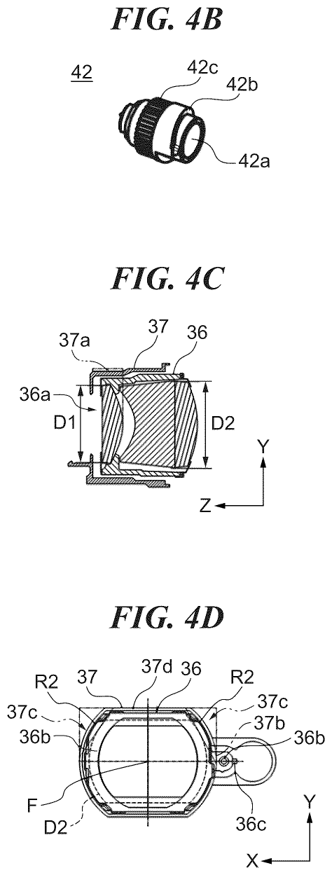

As shown in FIGS. 1A and 1B, an X direction, a Y direction, and a Z direction are defined with respect to the camera as follows. The X direction is a left-right direction (a horizontal direction) of the camera body 1. The Y direction is an up-down direction (a vertical direction) of the camera body. The Z direction is a direction of an optical axis of the interchangeable lens 2 when it is mounted on the camera body 1 and is a direction of an optical axis F (see FIG. 4D) of a finder 12 when it is housed in the camera body 1.

A front grip 3 is provided on a front surface of the camera body 1 so as to be projected forward of the camera body 1 for a user to grip the camera body 1. A mount part 4 to which the interchangeable lens 2 can be attached is provided at the center of the front surface of the camera body 1. The mount part 4 has an electric contact group 5. The camera body 1 communicates with the interchangeable lens 2 mounted on the mount part 4 and supplies power to the interchangeable lens 2 via the electric contact group 5. The interchangeable lens 2 mounted on the mount part 4 forms an image of an object on an image sensor 13.

A power lever 6, a mode dial 7, a release button 8, and an accessory shoe 9 are provided on an upper surface of the camera body 1. The power lever 6 is configured to switch ON/OFF of the power of the camera by a lever operation of a user. The mode dial 7 is configured to switch an image capturing mode among various modes by a rotation operation of the user. The release button 8 is configured to start image capturing by a press operation of the user. The accessory shoe 9 is disposed on the optical axis center of the interchangeable lens 2 and above the finder 12. Various external accessories for image capturing can be attached to the accessory shoe 9.

As shown in FIG. 1B, a display device 10, rear operation members 11, and the finder 12 are provided on a rear surface of the camera body 1. When the power of the camera is in an ON state and a still image mode or a moving image mode is set, the display device 10 or the finder 12 displays an image signal of an object image (a through image) being captured by the image sensor 13. Further, the display device 10 or the finder 12 displays image capturing parameters indicating image capturing conditions, such as a shutter speed and an aperture value.

The rear operation members 11 include a playback button for instructing playback of a captured image recorded. When the user operates the playback button, the captured image is played back and displayed on the display device 10 or the finder 12. The rear operation members 11 include a moving image button for instructing moving image capturing. When the user starts and stop the moving image capturing by operating the moving image button. A space 14 for placing a thumb of the user when the user grips the camera body 1 is provided on the side of the rear operation members 11.

The finder 12 is provided with a sensor window 15, an eyepiece window 16, and a diopter adjustment dial 17. The sensor window 15 is disposed below the eyepiece window 16 and is provided on an optical path of an internal eye-approach sensor 44a (see FIG. 4A). When the eye-approach sensor 44a detects that the user is looking into the eyepiece window 16, a display destination of the captured image and the image capturing parameters is switched from the display device 10 to a display panel 35 (see FIG. 4A) provided inside the finder 12.

The diopter adjustment dial 17 is disposed on a side surface of the finder 12 at the front grip 3 side. The diopter is adjusted by the user operating the diopter adjustment dial 17, and the user can confirm the display image by the finder 12 without defocus.

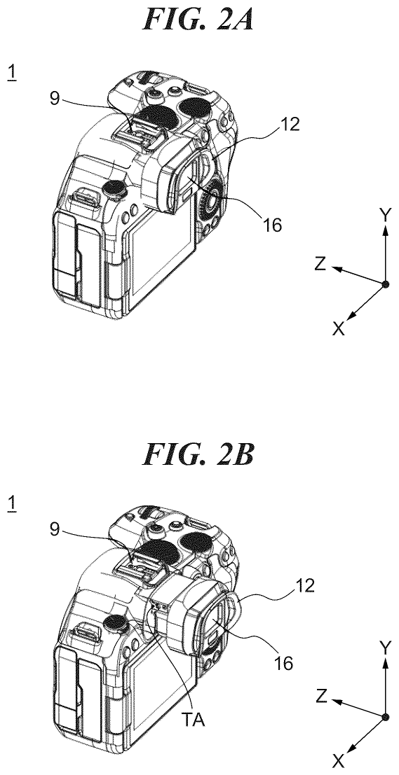

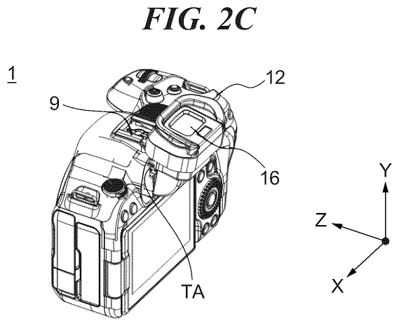

Next, states of the finder 12 will be described with reference to FIGS. 2A to 2C. FIG. 2A is a rear perspective view of the finder 12 showing a state in which the finder 12 is housed in the camera body 1 (hereinafter referred to as a housed state). FIG. 2B is a rear perspective view of the finder 12 showing a state in which the finder 12 is slid to the maximum along the optical axis F (see FIG. 4D) of the finder 12 from the housed state in FIG. 2A and is pulled out from the camera body 1 (hereinafter, referred to as a pulled-out state). FIG. 2C is a rear perspective view of the finder 12 showing a state in which the finder 12 in the pulled-out state shown in FIG. 2B is tilted around a tilt axis TA and then is restricted so as not to move in the tilt direction (hereinafter referred to as a tilt-lock state).

The tilt axis TA (rotation axis) is orthogonal to the optical axis F of the finder 12 and parallel to the X direction. In the tilt-lock state (a rotation lock state), as shown in FIG. 2C, the finder 12 can be locked stepwise at a predetermined angle from a tilt angle in the pulled-out state in FIG. 2B to the maximum tilt angle which is a tilt angle in a positional relationship where the eyepiece window 16 is approximately parallel to an accessory attachment surface of the accessory shoe 9. In the process in which the finder 12 is brought from the pulled-out state to the tilt-lock state, there is a tilt-unlock state (a rotatable state) in which the finder 12 can be tilted around the tilt axis TA.

The tilt axis TA is located outside the camera body 1 as shown in FIG. 2B and FIG. 2C when the finder 12 is in each of the pulled-out state, the tilt-unlock state, and the tilt-lock state. And the tilt axis TA moves from outside the camera body 1 into the camera body 1 as the finder 12 transitions to the housed state. As shown in FIG. 2A, when the finder 12 is in the housed state, the tilt axis TA does not appear in the external appearance of the camera, and is positioned inside the camera body 1. The finder 12 allows the user to confirm display contents via the eyepiece window 16 by looking into the eyepiece window 16 in any of the housed state, the pulled-out state, the tilt-unlock state, and the tilt-lock state.

Note that the camera concerning this embodiment can maintain usability and portability as with conventional cameras when the finder 12 is in the housed state. In this respect, the conventional cameras are difficult to capture an image while looking into the eyepiece window in a state where a large external accessory is attached to the accessory shoe because the external accessory becomes an obstacle. However, in this embodiment, when the finder 12 is set to the pulled-out state, an enough distance is secured between the accessory shoe 9 and the finder 12 even in a state where a large external accessory is mounted on the accessory shoe 9. Therefore, even in such a case, the user favorably captures an image while looking into the eyepiece window 16. Further, when the finder 12 is set to the tilt-lock state, a degree of freedom of an image capturing posture of the user is increased, and inadvertent movement is prevented when the user presses an eye against the finder 12.

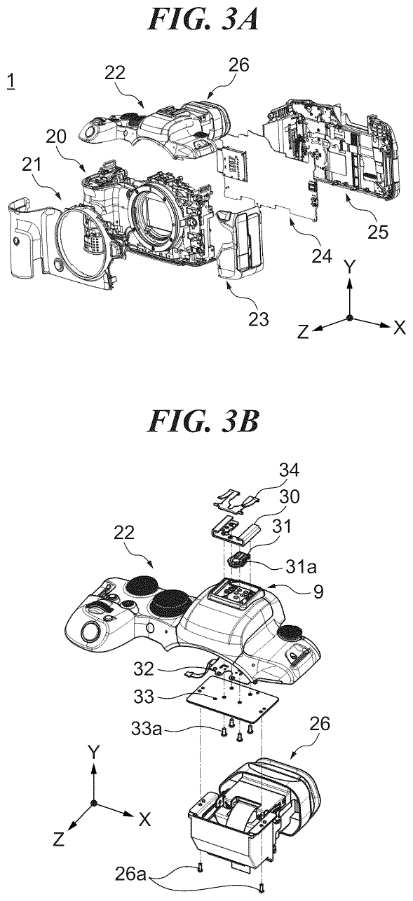

Next, a unit configuration of the camera body 1 will be described with reference to FIGS. 3A and 3B. FIG. 3A is an exploded perspective view of the camera body 1 showing the unit configuration of the camera body 1. In the camera body 1, units are assembled to an internal structural member 20. The units include a front cover unit 21, an upper cover unit 22, a side cover unit 23, a main board 24, and a rear cover unit 25. A finder unit 26 is assembled to the upper surface cover unit 22 from the inside, and the upper surface cover unit 22 is fixed to the internal structural member 20 in a state integrated with the finder unit 26.

FIG. 3B is an exploded perspective view showing a configuration for holding the accessory shoe 9 and the finder unit 26. The accessory shoe 9 is provided with an engagement member 30, a signal terminal stage 31, an accessory shoe flexible substrate 32, an accessory shoe holding member 33, and an accessory shoe spring 34.

The engagement member 30 is a member for engaging and holding an external accessory. The signal-terminal stage 31 is configured such that a contact-point member 31a for an external accessory is held by a base member formed of resin material. The accessory shoe flexible substrate 32 is electrically connected to the contact-point member 31a, and is connected to the main board 24 in a state where all the units of the camera body 1 is assembled, and is electrically connectable to the external accessory. As a result, various external accessories can communicate with the camera body 1 and function.

The accessory shoe holding member 33 is a component serving as a structural frame to hold the engagement member 30, and is a member having high rigidity and high strength in the upper surface cover unit 22. Four screws 33a penetrate the accessory shoe holding member 33, the accessory shoe flexible substrate 32, and the upper surface cover unit 22, and are fastened to the engagement member 30. Thus, the accessory shoe holding member 33 and the engagement member 30 are firmly held.

The signal terminal stage 31 is nipped and held between the engagement member 30 and the upper surface cover unit 22. The accessory shoe spring 34 is made of a conductive metal material and has an elastic deformation portion for biasing the mounted external accessory to a +Y side.

The finder unit 26 is assembled from the inside of the upper surface cover unit 22, and is fastened to the accessory shoe holding member 33 by two screws 26a and is firmly held.

Next, the finder 12 constituting the finder unit 26 will be described with reference to FIGS. 4A to 4D. FIG. 4A is an exploded perspective view of the finder 12 showing the configuration of the finder 12. An optical unit 12a of the finder 12 includes a display panel 35, a lens holder 36, a fixed barrel 37, a lens front cover 38, and a finder flexible substrate 39.

The lens holder 36 is a member that holds a lens group 36a (lens) that guides a light flux from the display panel 35 to the eyepiece window 16. A guide shaft 40 is a member that is inserted through a bearing 36b of the lens holder 36, and both ends of the guide shaft 40 are pivotably supported by the fixed barrel 37 and the lens front cover 38 to movably guide the lens holder 36 in the direction of the optical axis F (see FIG. 4D) of the lens. The spring 41 is disposed coaxially with the guide shaft 40 and is nipped between the lens holder 36 and the fixed barrel 37. Thus, the lens holder 36 is biased toward a −Z side by the spring 41.

FIG. 4B is an enlarged perspective view of a cam member 42. As shown in FIG. 4B, the cam member 42 has a bearing part 42a, a cam part 42b, and a gear part 42c that is formed at a constant pitch in a circumferential direction.

The cam member 42 is rotatably held by being nipped between the fixed barrel 37 and the lens front cover 38 in a state where a shaft part (not shown) of the fixed barrel 37 is inserted into the bearing part 42a. The lens holder 36 is biased to the −Z side by the spring 41, and thus a convex part 36c (refer to FIG. 4D) of the lens holder 36 always abuts against the cam part 42b of the cam member 42. Thus, the cam member 42 is rotatable integrally with the diopter adjustment dial 17, and the lens holder 36 is movable in the Z direction along the shape of the cam part 42b.

A plate spring 43 elastically engages with the gear part 42c of the cam member 42, thereby enabling the cam member 42 to click-stop at a pitch of the gear part 42c. That is, the user rotates the diopter adjustment dial 17 to move the lens holder 36 to a position corresponding to the diopter of the user, thereby adjusting the diopter of the finder 12.

The display panel 35 is bonded and fixed to the fixed barrel 37 with a double-sided tape (not shown). The finder flexible substrate 39 is a substrate for transmitting an image signal or the like from the main board 24, and is provided with a connector for connecting a display panel substrate 35a and a detection sensor flexible substrate 44. Therefore, the finder flexible substrate 39 is one of substrates for controlling display contents of the display panel 35, that is, the display contents of the finder 12. The finder flexible substrate 39 is positioned and fastened to the fixed barrel 37 with screws so as to cover the back surface of the display panel 35.

The detection sensor flexible substrate 44 is provided with the eye-approach sensor 44a that detects that the user is looking into the eyepiece window 16 and switches the display on the display device 10 to the display on the display panel 35. The detection sensor flexible substrate 44 is arranged so as to be pressed against the back surface of the sensor window 15 bonded and fixed to an outer cover 45, and is fastened with screws.

The lens front cover 38 has a flange part 38a formed in the circumferential direction and is assembled and fastened with screws so that the flange part 38a is nipped between the outer cover 45 and an inner cover 46. Thus, the optical unit 12a is covered with the outer cover 45 and the inner cover 46 that are exterior components.

On the +Z side of the inner cover 46, an arc part 46a that becomes appearance when the finder 12 is in the tilt-unlock state or the tilt-lock state and an opening part 46b for wiring the detection sensor flexible substrate 44 in the vicinity of the inside of the arc part 46a are provided. A rubber eyepiece cover 47 serving as a cushion part member when the user looks into the finder 12 is fixed to the outer cover 45 with screws.

FIG. 4C is a sectional view of the lens holder 36 and the fixed barrel 37 in an assembled state and is a YZ sectional view of the lens holder 36 and the fixed barrel 37 cut at the position of the optical axis F (see FIG. 4D) of the finder 12.

As shown in FIG. 4C, the lens group 36a in the lens holder 36 includes a plurality of lenses. In the lens group 36a, lens outer shapes D1 and D2 are enlarged to the display panel 35 in order to enlarge the display of the display panel 35. Further, the lens outer shape D2 on the eyepiece window 16 side is larger than the lens outer shape D1 on the display panel 35 side. That is, the upper portion of the lens on the display panel 35 side is configured to have a space corresponding to a half of the difference (D2−D1) between the lens outer shapes. Further, a substantially rectangular space 37a is formed in the fixed barrel 37 covering the lens holder 36 above the lens on the display panel 35 side. In FIG. 4C, the outer shape in the Y direction in the sectional view cut along a plane orthogonal to the X-axis has been described, the same can be applied to the outer shape in the X direction in the sectional view cut along a plane orthogonal to the Y-axis.

FIG. 4D is a front view of the lens holder 36 and the fixed barrel 37 in the assembled state and is a side view of the lens holder 36 and the fixed barrel 37 as viewed from the −Z side. A broken line in FIG. 4D indicates the lens outer shape D2 on the eyepiece window 16 side, which is the maximum outer shape of the lens group 36a described in FIG. 4C.

The lens holder 36 is formed with an arc part R2 formed on the +Y side than the optical axis F of the lens and bilaterally symmetrically with respect to the optical axis F of the lens, and is configured such that a substantially triangular space 37c is formed between the arc part R2 and an upper surface 37d and a side surface 37b of the fixed barrel 37. The optical axis F of the lens indicates the center of the lens in the front view in FIG. 4D. Therefore, it may be referred to as the finder lens center F, hereinafter. The bearing 36b is a bearing of the lens holder 36 described above. The convex part 36c is a convex part of the lens holder 36 described above.

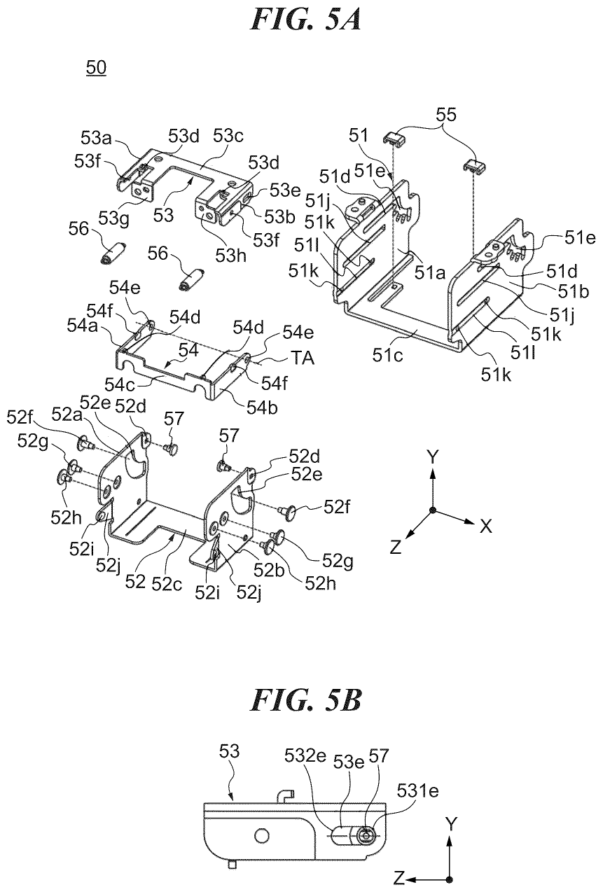

Next, a support mechanism 50 that supports the finder 12 so as to be movable between a plurality of states will be described with reference to FIGS. 5A to 8B. The support mechanism 50 is provided in the camera body 1. FIG. 5A is an exploded perspective view of the support mechanism 50. The support mechanism 50 has a lock mechanism. The lock mechanism supports the finder 12 so as to be movable between the housed state and the pulled-out state, between the pulled-out state and the tilt-unlock state, and between the tilt-unlock state and the tilt-lock state, and further supports so as to be able to restrict in the tilt direction at predetermined angles in the tilt-lock state.

The support mechanism 50 includes a fixed plate 51, a rectilinear plate 52, a rectilinear tilt plate 53 (rectilinear rotation plate), a tilt plate 54 (rotation plate), rectilinear plate support parts 55, tension springs 56, and rotation shaft pins 57. The fixed plate 51 is manufactured by pressing a metal plate and is a component serving as a structural skeleton of the support mechanism 50. The fixed plate 51 is fixed to the camera body 1. The fixed plate 51 has a first plane part 51a and a second plane part 51b. The first plane part 51a and the second plane part 51b are substantially parallel to the Z direction and substantially orthogonal to the X direction, and are opposed to each other in the axial direction of the tilt axis TA (see FIG. 2B and FIG. 2C). The first plane part 51a and the second plane part 51b are connected to a third plane part 51c that is parallel to the X direction and the Z direction. Thus, the fixed plate 51 is formed in a substantially U-shape.

Each of the first plane part 51a and the second plane part 51b is provided with a first linear rail 51d extending linearly in the rectilinear direction (Z direction) of the rectilinear plate 52. The rectilinear direction (Z direction) of the rectilinear plate 52 is orthogonal to the axial direction of the tilt axis TA. A tilt rail 51e (an outer arc-shaped rail) extends from an end on the-Z side (an end on a side toward which the finder is pulled out) of the first linear rail 51d to the-Y side. In the following description, the point in the first linear rail 51d from which the tilt rail 51e extends is referred to as a tilt rail base end.

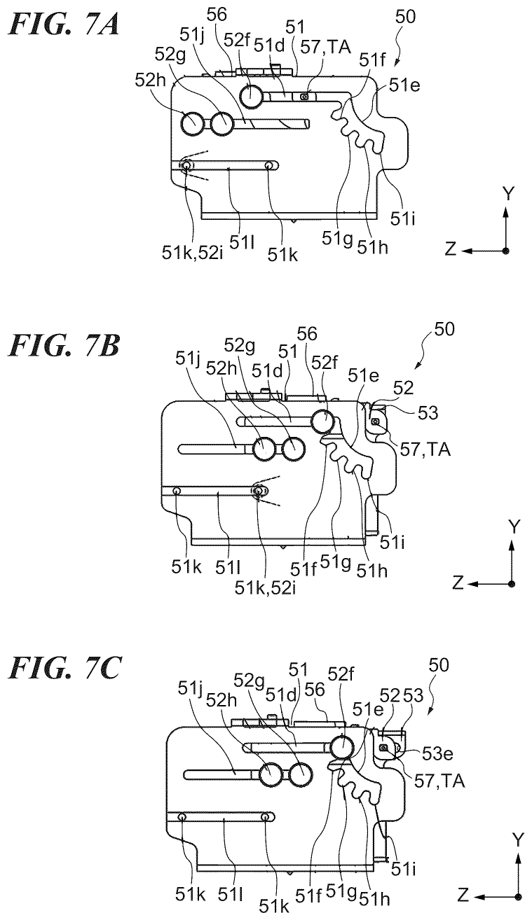

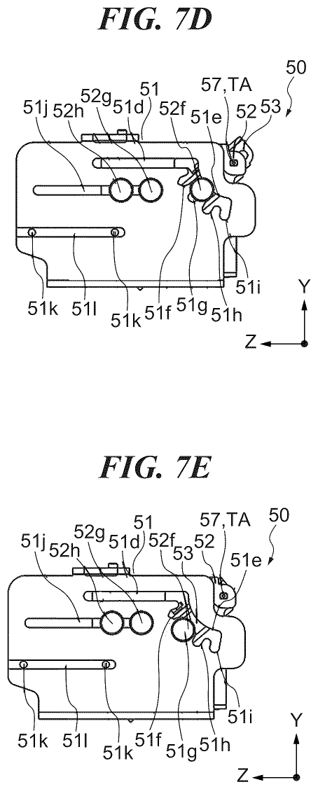

The tilt rail 51e is an arc-shaped rail extending along the circumferential direction of a circle centered on the rotation shaft pin 57, and has key grooves 51f, 51g, 51h and 51i (see FIGS. 7A to 7E) extending from the arc-shaped rail toward the outside of the circle centered on the rotation shaft pin 57. Further, a second linear rail 51j is formed in each of the first plane part 51a and the second plane part 51b in parallel to the first linear rail 51d. Further, a concave part 51l (an engaged part) extending linearly in the rectilinear direction (Z direction) of the rectilinear plate 52 and click holes 51k at both sides of the concave part 51l are formed in each of the first plane part 51a and the second plane part 51b.

The rectilinear plate 52 is a component that is manufactured by pressing a metal plate and is disposed inside the fixed plate 51. The rectilinear plate 52 is held by the fixed plate 51 so as to be movable only in the Z direction relative to the fixed plate 51.

The rectilinear plate 52 has a first plane part 52a and a second plane part 52b. The first plane part 52a and the second plane part 52b are substantially parallel to the Z direction and substantially orthogonal to the X direction, and are opposed to each other in the axial direction of the tilt axis TA. The rectilinear plate 52 is disposed adjacent to the inside of the substantially U-shaped fixed plate 51, and the first plane part 52a and the second plane part 52b of the rectilinear plate 52 are positioned between the first plane part 51a and the second plane part 51b of the fixed plate 51. A hole 52d and a tilt rail 52e (an inner arc-shaped rail) are formed in each of the first plane part 52a and the second plane part 52b.

The center of the hole 52d serves as the tilt axis TA. The tilt rail 52e has an arc shape that can surround the tilt rail 51e and the key grooves 51f, 51g, 51h, and 51i of the fixed plate 51. When the finder 12 is in the pulled-out state, the tilt-unlock state, or the tilt lock state, the tilt rail 51e and the key grooves 51f, 51g, 51h, and 51i of the fixed plate 51 are disposed in the tilt rail 52e and the tilt rail 51e and the key grooves 51f, 51g, 51h, and 51i of the rectilinear plate 51 are surrounded by the tilt rail 52e when the support mechanism 50 is viewed in the X direction.

The rectilinear plate 52 is provided with plate spring parts 52j that protrude from the first plane part 52a and the second plane part 52b, respectively, toward the fixed plate 51. Convex parts 52i (engaging parts) of the plate spring parts 52j are elastically engaged with the concave parts 51l or the click holes 51k of the fixed plate 51.

Two pairs of linear guide shafts 52g and 52h are coupled to the rectilinear plate 52 and move within the second linear rails 51j of the fixed plate 51 during a linear movement of the rectilinear plate 52. Specifically, the linear guide shafts 52g and 52h are inserted through the second linear rails 51j and one pair is caulked to the first plane part 52a of the rectilinear plate 52 and the other pair is caulked to the second plane part 52b in a state where the rectilinear plate 52 is disposed adjacent to the inside of the substantially U-shaped fixed plate 51.

The first plane part 52a and the second plane part 52b are connected to a third plane part 52c that is parallel to the X direction and the Z direction. Thus, the rectilinear plate 52 is formed in a substantially U-shape. A rail of a convex shape (hereinafter referred to as a convex-shaped rail) (not shown) extending in the rectilinear direction (Z direction) of the rectilinear plate 52 is provided on a bottom surface of the third plane part 52c. The convex-shaped rail contacts the rectilinear plate support part 55 provided on the fixed plate 51 and slides on the rectilinear plate support part 55. The rectilinear plate support part 55 has caulking shafts made of resin and is fixed to the fixed plate 51 by thermal caulking.

When the rectilinear plate 52 moves in the rectilinear direction (Z direction), the rectilinear plate 52 can move rectilinearly in the Z direction with respect to the fixed plate 51 due to the sliding of the convex-shaped rail and the rectilinear guide shafts 52g and 52h.

With the configuration described above, it is possible to obtain an operational feeling when the rectilinear plate 52 moves linearly and a click-stop feeling when the finder 12 is in the housed state or the pulled-out state, while suppressing the size up of the support mechanism 50.

The rectilinear tilt plate 53 is a component that is manufactured by pressing a metal plate and is disposed inside the rectilinear plate 52. The rectilinear tilt plate 53 is a component that can tilt and rotate about the tilt axis TA with respect to the rectilinear plate 52, and is held by the tilt plate 54 so as to be able to move rectilinearly with respect to the tilt plate 54. The finder 12 is fixed to the rectilinear tilt plate 53, and the finder 12 moves integrally with the rectilinear tilt plate 53.

The rectilinear tilt plate 53 has a first plane part 53a and a second plane part 53b. The first plane part 53a and the second plane part 53b are substantially parallel to the Z direction and substantially orthogonal to the X direction, and are opposed to each other in the axial direction of the tilt axis TA. The first plane part 53a and the second plane part 53b are located on the +Y side than the finder lens center F and are connected to a third plane part 53c that is parallel to the Z direction and the X direction. Thus, the rectilinear tilt plate 53 is formed in a substantially U-shape.

The first plane part 53a and the second plane part 53b are each provided with a long hole 53e through which the rotation shaft pin 57 is inserted. Further, the first plane part 53a and the second plane part 53b are each provided with a hole 53f through which a key shaft 53f described later is inserted. Further, a hook part 53d for locking the tension spring 56 is provided on the third plane part 53c.

The tilt plate 54 is a component that is manufactured by pressing a metal plate and is disposed inside the rectilinear tilt plate 53. Further, the tilt plate 54 is a component that can tilt and rotate around the tilt axis TA with respect to the rectilinear plate 52.

The tilt plate 54 has a first plane part 54a and a second plane part 54b. The first plane part 54a and the second plane part 54b are substantially parallel to the Z direction and substantially orthogonal to the X direction, and are opposed to each other in the axial direction of the tilt axis TA. The first plane part 54a and the second plane part 54b are located on the +Y side than the finder lens center F and are connected to a third plane part 54c that is parallel to the X direction and the Y direction. Thus, the tilt plate 54 is formed in a substantially U-shape. The first plane part 54a and the second plane part 54b of the tilt plate 54 are located between the first plane part 52a and the second plane part 52b of the rectilinear plate 52.

The first plane part 54a and the second plane part 54b are each provided with a hole 54e through which the rotation shaft pin 57 is inserted. Further, the first plane part 54a and the second plane part 54b are each provided with a convex part 54f protruding to the +Y side. Further, the third plane part 54c is provided with a hook part 54d for locking the tension spring 56.

The rotation shaft pin 57 is caulked in a state of being inserted through the hole 54e of the tilt plate 54, the long hole 53e of the rectilinear tilt plate 53, and the hole 52d of the rectilinear plate 52, and thus forms the tilt axis TA that is the rotation center of the support mechanism 50. Each of key shafts 52f is inserted through the first linear rail 51d, the tilt rail 51e, the tilt rail 52e, and the hole 53f, and are caulked to the first plane part 53a or the second plane part 53b of the rectilinear tilt plate 53 in a state where the rotation shaft pins 57 are caulked. The key shafts 52f are connected to the rectilinear tilt plate 53, and move in the tilt rails 51e of the fixed plate 51 and the tilt rails 52e of the rectilinear plate 52 during the rotation of the rectilinear tilt plate 53 and the rectilinear plate 52. The key shafts 52f move in the first linear rails 51d while the rectilinear plate 52 moves linearly.

The rectilinear plate 52 is restricted in the tilt direction by the linear guide shafts 52g and 52h, and is configured not to move inadvertently when the rectilinear tilt plate 53 and the tilt plate 54 are tilted. The rectilinear tilt plate 53 further has a fourth plane part 53g and a fifth plane part 53h.

FIG. 5B is a view for explaining the long hole 53e of the rectilinear tilt plate 53. The long hole portion 53e has a shape having a center line parallel to the Z-axis, and has an arc 531e on the −Z side and an arc 532e on the +Z side. The rectilinear tilt plate 53 is linearly movable in the same direction as the center line of the long hole 53e within the range of the long hole 53e via the rotation shaft pin 57. In this way, the rectilinear tilt plate 53 is held by the tilt plate 54 so as to be linearly movable.

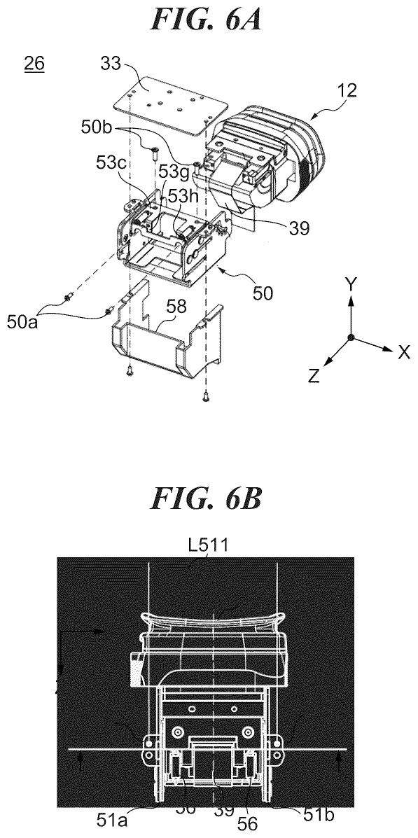

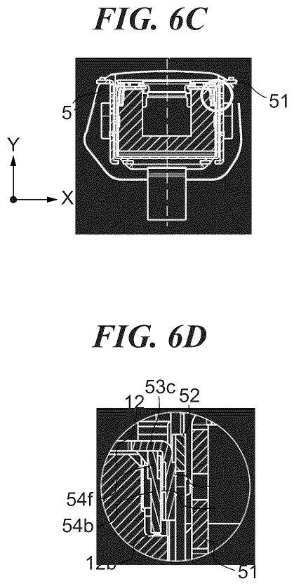

FIGS. 6A to 6D are views for describing the configuration of the finder unit 26. FIG. 6A is an exploded perspective view of the finder unit 26. As shown in FIG. 6A, the finder unit 26 includes the finder 12, the accessory shoe holding member 33, the support mechanism 50, and a support mechanism holder 58.

The rectilinear tilt plate 53 is provided with the fourth plane part 53g and the fifth plane part 53h that are orthogonal to the Z direction. The finder 12 and the support mechanism 50 are fastened to each other by screws 50a through the fourth plane part 53g and the fifth plane part 53h. Further, the finder 12 and the support mechanism 50 are fastened by screws 50b through the third plane part 53c of the rectilinear tilt plate 53. Thus, the finder 12 moves integrally with the rectilinear tilt plate 53.

FIG. 6B is a top view of the finder unit 26 viewed from the +Y side while not showing the accessory shoe holding member 33 and the support mechanism holder 58. FIG. 6C is a sectional view obtained by cutting the finder unit 26 at the position of VIC-VIC in FIG. 6B. Further, FIG. 6D is a partially enlarged view of a portion A in FIG. 6C.

As shown in FIG. 6B, the two tension springs 56 are respectively disposed between the finder flexible substrate 39 (flexible substrate) and the first plane part 51a of the fixed plate 51 and between the finder flexible substrate 39 (flexible substrate) and the second plane part 51b of the fixed plate 51 in the X direction. Further, the third plane part 53c of the rectilinear tilt plate 53 is disposed in the substantially rectangular space 37a of the optical unit 12a described above. Thus, it is possible to suppress the size up of the support mechanism 50 in the X, Y, and Z directions due to the addition of the rectilinear tilt plate 53, the tilt plate 54, and the tension springs 56. The pair of plane parts 53a and 53b of the rectilinear tilt plate 53 and the pair of plane parts 54a and 54b of the tilt plate 54 are disposed in the substantially triangular space 37c of the optical unit 12a described above. This makes it possible to suppress the size up of the support mechanism 50 in the X direction due to the addition of the rectilinear tilt plate 53 and the tilt plate 54. As described above, it is possible to suppress the size up of the finder unit 26 in the X, Y, and Z directions.

The arrangement of the components that constitute the support mechanism 50 will now be described with reference to FIG. 6C, which is a partially enlarged view of a portion A in the VIC-VIC sectional view in FIG. 6D. As for the components constituting the support mechanism 50, the fixed plate 51, the rectilinear plate 52, the rectilinear tilt plate 53, and the tilt plate 54 are arranged in this order from the outside of the camera body 1 toward the finder lens center F in the X direction.

The fixed plate 51 is a component fastened to the camera body 1, and it is preferable to make an interval L511 (see FIG. 6B) between the fastening portions as wide as possible from the viewpoint of rigidity. Therefore, in the support mechanism 50, the fixed plate 51 is disposed at a position farthest from the finder lens center F, that is, at the outermost side.

The rectilinear plate 52 has the plate spring parts 52j that elastically engages with the concave parts 51l and the click holes 51k of the fixed plate 51, and therefore, is arranged adjacent to the inner side of the fixed plate 51. The key shaft 52f is inserted into the hole 53f of the rectilinear tilt plate 53 through the first linear rail 51d and the tilt rail 51e of the fixed plate 51 and the tilt rail 52e of the rectilinear plate 52. From the viewpoint of tolerance, it is preferable that the key shaft 52f is as short as possible. Therefore, the rectilinear tilt plate 53 is disposed adjacent to the inner side of the rectilinear plate 52.

As described above, in the support mechanism 50, the fixed plate 51, the rectilinear plate 52, the rectilinear tilt plate 53, and the tilt plate 54 are arranged in this order from the outside of the camera body 1 toward the finder lens center F in the X direction. Thus, the size up of the support mechanism 50 can be suppressed without impairing the operation feeling.

Further, the second plane part 54b of the tilt plate 54 is disposed between the third plane part 53c of the rectilinear tilt plate 53 and a convex part 12b of the finder 12, and the first plane part 54a of the tilt plate 54 is also disposed in the same manner. When the rectilinear tilt plate 53 moves linearly, the third plane part 53c of the rectilinear tilt plate 53 slides on the convex parts 54f of the first plane part 54b and the second plane part 54f of the tilt plate 54, and during the sliding, contacts the convex parts 54f of the first plane part 54a and the second plane part 54b of the tilt plate 54. This configuration can minimize the frictional resistance and roughness during the operation of the finder 12.

FIGS. 7A to 7E are side views illustrating operational transitions of the support mechanism 50. FIG. 7A is a side view showing the support mechanism 50 when the finder 12 is in the housed state. FIG. 7B is a side view showing the support mechanism 50 when the finder 12 is in the pulled-out state.

When the finder 12 is transitioned from the housed state to the pulled-out state, the rectilinear plate 52, the rectilinear tilt plate 53, and the tilt plate 54 are moved to the −Z side by the operation force of the user applied to the finder 12 (the force applied to the finder 12 by the operation of drawing the finder 12). As a result, the key shaft 52f moves linearly along the first linear rail 51d of the fixed plate 51. The linear guide shafts 52g and 52h move linearly along the second linear rail 51j of the fixed plate 51. Further, since the convex part 52i of the rectilinear plate 52 is elastically and detachably engaged with the concave part 51l or the click hole 51k of the fixed plate 51, an operational feeling can be obtained when the finder 12 is transitioned from the housed state to the pulled-out state.

When the finder 12 is transitioned from the housed state to the pulled-out state, the linear guide shaft 52g abuts against the end on the −Z side of the second linear rail 51j of the fixed plate 51 (one end of the second linear rail 51j). At this time, the key shaft 52f is positioned in front of the end on the −Z side of the first linear rail 51d (one end of the first linear rail 51d), that is, in front of the tilt rail base end. Therefore, the rectilinear tilt plate 53 to which the key shaft 52f is caulked is in a regulated state so as not to move carelessly in the tilt direction. In this way, in the state where the rectilinear plate 52 is moving linearly in conjunction with the pulling operation of the finder 12, the linear guide shaft 52g abuts against one end of the second linear rail 51j, and the key shaft 52f remains in the first linear rail 51d, whereby the finder 12 transitions to the pulled-out state.

FIG. 7C is a side view showing the support mechanism 50 when the finder 12 is in the tilt-unlock state. When the finder 12 is in the pulled-out state, the rotation shaft pin 57 serving as the tilt axis TA is in contact with the arc 53e on the −Z side of the long hole 531e of the linear tilt plate 53 as shown in FIG. 5B mentioned above. Therefore, the rectilinear tilt plate 53 is linearly movable to the −Z side within the range of the long hole 53e. Therefore, the rectilinear tilt plate 53 is further moved to the −Z side by the operation force of the user applied to the finder 12 (the force applied to the finder 12 by the operation of pulling out the finder 12). As a result, the rotation shaft pin 57 (tilt axis TA) abuts against the arc 532e on the +Z side of the long hole 53e of the linear tilt plate 53, and the key shaft 52f moves to the end on the −Z side of the first linear rail 51d, that is, the tilt rail base end.

In this way, when the finder 12 is in the pulled-out state, the rectilinear tilt plate 53 moves linearly in conjunction with the pulling-out operation of the finder 12, and therefore, the key shaft 52f moves to one end of the first linear rail 51d extending from the tilt rail 51e, and the finder 12 becomes rotatable. As a result, the finder 12 is transitioned from the pulled-out state to the tilt-unlock state.

Note that a movable end of the tension spring 56 is engaged with the hook part 53d of the rectilinear tilt plate 53 and a fixed end is engaged with the hook part 54d of the tilt plate 54. With such a configuration, a biasing force of the tension spring 56 biases the rectilinear tilt plate 53 to the opposite side (+Z side) to the direction in which the finder 12 is pulled out in the pull-out/housing direction of the finder 12 (the direction in which the finder 12 is slid during the transition between the housed state and the pulled-out state, the Z direction in this embodiment). Thus, the tension spring 56 smoothly expands and contracts when the rectilinear tilt plate 53 moves linearly within the range of the long hole 53e. The biasing force of the tension spring 56 generates or changes a force required for operating the finder 12 when the finder 12 is transitioned from the pulled-out state to the tilt-unlock state.

FIG. 7D is a side view showing a state where the rectilinear tilt plate 53 is tilted together with the tilt plate 54 in the support mechanism 50 when the finder 12 is in the tilt-unlock state. When the finder 12 is transitioned from the pulled-out state to the tilt-unlock state, the key shaft 52f is positioned at the end portion of the first linear rail 51d on the −Z side, that is, the tilt rail base end. Therefore, the key shaft 52f can move into the tilt rail 51e, which has an arc shape centered on the rotation shaft pin 57 (tilt axis TA), of the fixed plate 51 and the tilt rail 52e of the rectilinear plate 52. Thus, as shown in FIG. 7D, the rectilinear tilt plate 53 can be rotated around the rotation shaft pin 57 (tilt axis TA) together with the tilt plate 54 by the operation force of the user to the finder 12.

The four key grooves 51f, 51g, 51h, and 51i extend from the tilt rail 51e of the fixed plate 51 at equal intervals toward the side opposite to the side of the rotation shaft pin 57 (tilt axis TA). When the finder 12 is in the pulled-out state and the tilt-unlock state, the extension lines of the center lines of the key grooves 51f, 51g, 51h, and 51i pass through the center of the rotation shaft pin 57 (tilt axis TA) when the support mechanism 50 is viewed from the X direction. Therefore, among the center lines of the key grooves 51f, 51g, 51h, and 51i, the center line on which the center of the key shaft 52f is positioned coincides with the center line of the long hole 53e of the rectilinear tilt plate 53. This point is the same when the finder 12 is in the tilt lock state.

FIG. 7E is a side view of the support mechanism 50 when the finder 12 is in the tilt-lock state. When the finder 12 is at the tilt-unlock state, the rectilinear tilt plate 53 is rotated around the rotation shaft pin 57 (tilt axis TA) together with the tilt plate 54 by the operation force of the user to the finder 12. When the operation force is removed, the rectilinear tilt plate 53 is moved by the tension spring 56 to the side (one side) away from the rotation shaft pin 57 (tilt axis TA) along the same direction as the center line of the long hole 53e. In conjunction with this, the key shaft 52f caulked to the rectilinear tilt plate 53 moves in the tilt rail 51e of the fixed plate 51. Further, the key shaft 52f fits into the closest key groove among the key grooves 51f, 51g, 51h, and 51i.

In this way, when the finder 12 is in the tilt lock state, the key shaft 52f is fitted in any one of the key grooves 51f, 51g, 51h, and 51i, and the rectilinear tilt plate 53 is regulated so as not to be carelessly moved in the tilt direction. This can prevent a decrease in usability of the finder 12 when the user's eye is pressed to the finder 12.

On the other hand, when the finder 12 transitions from the tilt lock state to the tilt-unlock state, the operational transition of the support mechanism 50 is as follows. The rectilinear tilt plate 53 is moved toward the side (opposite side) approaching the rotation shaft pin 57 (tilt axis TA) along the same direction as the center line of the long hole portion 53e of the rectilinear tilt plate 53 against the force of the tension spring 56 by the operation force of the user to the finder 12. In conjunction with this, the key shaft 52f is disengaged from the fitted one of the key grooves 51f, 51g, 51h, and 51i, and is brought into a state of being movable in the tilt rail 51e. Thus, the biasing force of the tension spring 56 generates or changes a force required for operating the finder 12 when the finder 12 is transitioned from the tilt lock state to the tilt-unlock state.

In this way, the support mechanism 50 constitutes a lock mechanism that can fix the finder 12 at a predetermined tilt angle while ensuring a large tilt angle of the finder 12. Further, the finder 12 can be fixed at a plurality of tilt angles by the four key grooves 51f, 51g, 51h, and 51i. Although the four key grooves 51f, 51g, 51h, and 51i extend from the tilt rail of the fixed plate 51 at the equal intervals, the number of key grooves is not limited to four, and the intervals between the key grooves are arbitrary.

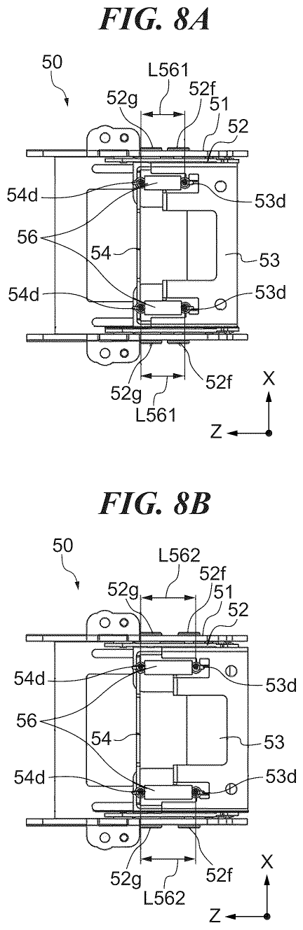

FIGS. 8A and 8B are views for explaining a configuration to lock the finder 12. FIG. 8A is a top view of the support mechanism 50 in FIG. 7B, that is, the support mechanism 50 in the state where the finder 12 is in the pulled-out state, as viewed from the +Y side. FIG. 8B is a top view of the support mechanism 50 in FIG. 7C, that is, the support mechanism 50 in the state where the finder 12 is transitioned from the pulled-out state to the tilt-unlock state, as viewed from the +Y side.

A spring length L561 of the tension spring 56 in the state where the finder 12 is in the pulled-out state is shorter than a spring length L562 of the tension spring 56 in the state where the finder 12 is in the tilt-unlock state. That is, when the finder 12 is transitioned from the pulled-out state to the tilt-unlock state, the biasing force of the tension spring 56 acts on the rectilinear tilt plate 53 and the tilt plate 54, and generates or changes the force necessary for the operation of the finder 12. When the finder 12 is in the tilt-unlock state, if the operation force of the user to the finder 12 (the force applied to the finder 12 by the operation of tilting the finder 12) is removed, the position of the rectilinear tilt plate 53 returns to the position when the finder 12 is in the pulled-out state by the biasing force of the tension spring 56.

Further, since the spring length L561 of the tension spring 56 in the case where the finder 12 is the pulled-out state is made larger than the natural length of the tension spring 56, the biasing force of the tension spring 56 acts on the rectilinear tilt plate 53 even in the case where the finder 12 is in the pulled-out state. Further, the biasing force is set to be larger than the force that is required for operating the finder 12 when the finder 12 is transitioned from the housed state to the pulled-out state, that is, larger than a frictional force between the convex part 52i of the plate spring part 52j of the rectilinear plate 52 and the concave part 51l of the fixed plate 51. Thus, when the finder 12 is transitioned from the housed state to the pulled-out state, the tension spring 56 is prevented from being unexpectedly expanded and contracted.

Further, the force that is required for operating the finder 12 when the finder 12 is transitioned from the housed state to the pulled-out state is generated or changed by the frictional force that is generated by the rectilinear plate 52 moving linearly while the convex part 52i of the plate spring part 52j thereof is elastically engaged with the concave part 51l of the fixed plate 51. On the other hand, the force required for operating the finder 12 when the finder 12 is in the tilt-unlock state is generated or changed by the biasing force of the tension spring 56. In this way, in the first embodiment, it is possible to clearly distinguish the force required for operating the finder 12 when the finder 12 is transitioned from the housed state to the pulled-out state from the force required for operating the finder 12 when the finder 12 is in the tilt-unlock state.

As described above, the camera concerning the first embodiment can rotate the finder 12 pulled out from the camera body 1 and lock the finder 12 at the rotated position by using the (built-in) support mechanism 50 built in the main body of the electronic apparatus.

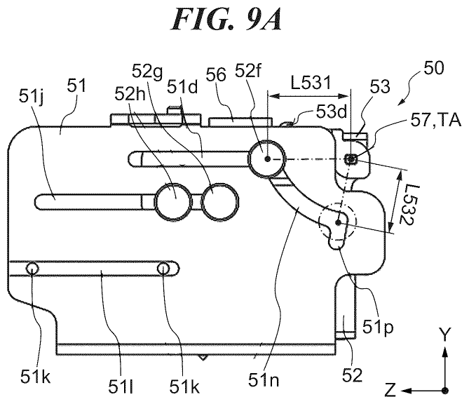

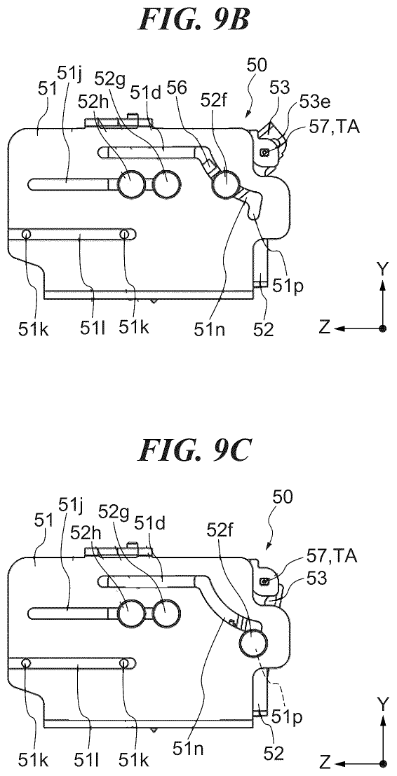

Hereinafter, a second embodiment will be described with reference to FIGS. 9A to 9C, but the description will be made focusing on differences from the first embodiment described above, and the description of the same matters will be omitted. FIGS. 9A to 9C are side views showing the operation transition of the support mechanism 50.

In the second embodiment, a tilt rail 51n and a key groove 51p are formed in the fixed plate 51 of the support mechanism 50 instead of the tilt rail 51e and the key grooves 51f, 51g, 51h, and 51i. In the following description, a position that is the end on the −Z side of the first linear rail 51d and at which the tilt rail 51n extends from the first linear rail 51d is referred to as a tilt rail base end.

The key groove 51p extends to the side opposite to the side of the rotation shaft pin 57 (tilt axis TA) at the tip end of the tilt rail 51n. In viewing the support mechanism 50 from the X direction, an extension line of the center line of the key groove 51p passes through the center of the rotation shaft pin 57 (tilt axis TA) in the pulled-out state, the tilt-unlock state, and the tilt-lock state of the finder 12.

Although tilt rail 51n is arc-shaped, the distance from the rotation shaft pin 57 (tilt axis TA) to the tilt rail 51n vary in accordance with the location on the tilt rail 51n. Specifically, the tilt rail 51n has a shape in which the distance to the center of the rotation shaft pin 57 (tilt axis TA) in the pulled-out state of the finder 12 varies and becomes shorter toward the tip end where the key groove 51p is provided. This point is the same when the finder 12 is in the tilt-unlock state and the tilt-lock state. As described above, a locus of the key shaft 52f from the tilt rail base end to the tip end portion of the tilt rail 51n has a shape in which the distance between the center of the key shaft 52f and the center of the rotation shaft pin 57 (tilt axis TA) monotonously decreases. Therefore, a distance L531 from the center of the key shaft 52f located at the tilt rail base end to the center of the rotation shaft pin 57 is longer than a distance L532 from the center of the key shaft 52f located at the tip end of the tilt rail 51n to the center of the rotation shaft pin 57.

In this way, as the key shaft 52f moves in the tilt rail 51n toward its tip end at which the key groove 51p is provided, the distance to the rotation shaft pin 57 (tilt axis TA) becomes shorter. Therefore, as the key shaft 52f moves in the tilt rail 51n toward its tip end, the rectilinear tilt plate 53 moves to the −Z side, the tension spring 56 expands, which can increase the biasing force of the tension spring 56. Thus, when the key shaft 52f moves to the tip end of the tilt rail 51n, it is fitted into the key groove 51p by the biasing force of the tension spring 56.

In the second embodiment, when the linear guide shaft 52g abuts against one end of the second linear rail 51j and the key shaft 52f moves to one end of the first linear rail 51d in the state where the rectilinear plate 52 is moving rectilinearly in conjunction with the pull-out operation of the finder 12, the finder 12 transitions to the pulled-out state and the finder 12 becomes rotatable.

When the linear guide shaft 52g abuts against the end on the −Z side of the second linear rail 51j of the fixed plate 51, the key shaft 52f is positioned at the end on the −Z side of the first linear rail 51d, that is, the tilt rail base end. Therefore, the position of the key shaft 52f at the tilt rail base end corresponds to the position of the key shaft 52f when the finder 12 is in the pulled-out state in the first embodiment. Further, the position of the key shaft 52f at the tilt rail base end also corresponds to the position of the key shaft 52f when the finder 12 is transitioned from the pulled-out state to the tilt-unlock state in the first embodiment.

In the first embodiment, when the finder 12 is transitioned from the pulled-out state to the tilt-unlock state and the key shaft 52f becomes movable in the tilt rail 51e, the rectilinear tilt plate 53 needs to be moved to the −Z side, and thus the biasing force of the tension spring 56 increases. However, in the second embodiment, even when the finder 12 is in the pulled-out state, the key shaft 52f can move in the tilt rail 51n without moving the rectilinear tilt plate 53 to the −Z side. With such a configuration, in the second embodiment, the finder 12 can seamlessly transition from the pulled-out state to the tilt-unlock state.

As described above, the camera concerning the second embodiment can rotate the finder 12 pulled out from the camera body 1 and lock the finder 12 at the rotated position by using the support mechanism 50 built in the main body of the electronic apparatus.

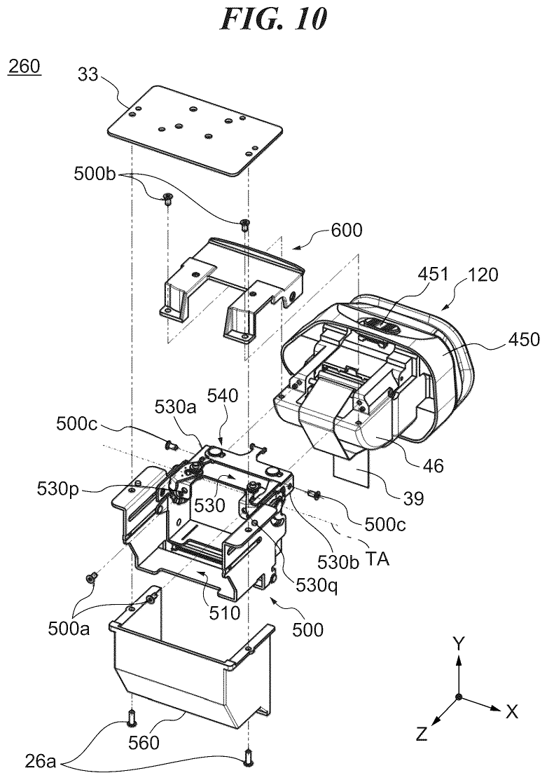

Hereinafter, a third embodiment will be described with reference to FIGS. 10 to 14E, but the description will be made focusing on the difference from the first embodiment and the second embodiment described above, and the description of the same matters will be omitted.

In the first embodiment, the finder 12 transitions to the tilt-unlock state by further pulling out from the pulled-out state and can be tilted and rotated. The finder 12 after the tilting is regulated in the tilt direction by the key shaft 52f being fitted into any one of the key grooves 51f, 51g, 51h, and 51i by the tension spring 56. In the second embodiment, the finder 12 is seamlessly transitioned from the pulled-out state to the tilt-unlock state and can be tilted and rotated. The finder 12 after the tilting is regulated in the tilt direction by the fitting of the key shaft 52f into the key groove 51p by the tension spring 56.

FIG. 10 is an exploded perspective view for explaining a configuration of a finder unit 260 of the third embodiment. In the third embodiment, a support mechanism 500, a lock mechanism 540, a lock lever 451, and the like are different from those of the first embodiment and the second embodiment.

As shown in FIG. 10, the finder unit 260 has a finder 120, the support mechanism 500, a support mechanism holder 560, and a lock mechanism cover 600. The finder unit 260 is assembled from the inside of the upper surface cover unit 22 (see FIG. 3A and FIG. 3B), and is fastened to the accessory shoe holding member 33 by the two screws 26a through a fixed plate 510 and is firmly held.

A fourth plane part 530p (orthogonal plane part) and a fifth plane part 530q (orthogonal plane part) that are orthogonal to the Z direction are formed in a rotation plate 530 of the support mechanism 500. The rotation plate 530 is fastened to the finder 120 by screws 500a through the fourth plane part 530p and the fifth plane part 530q.

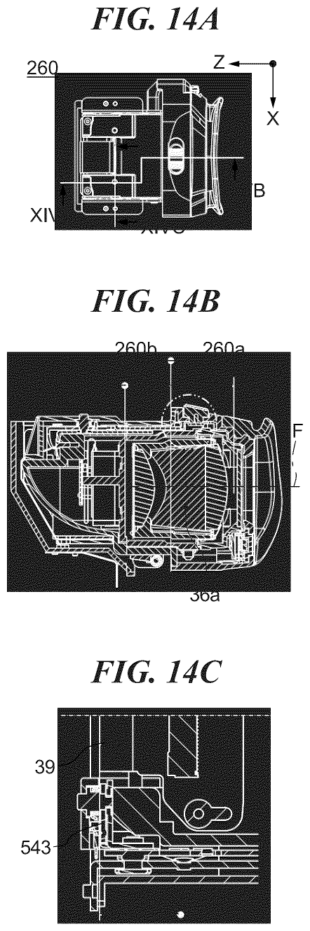

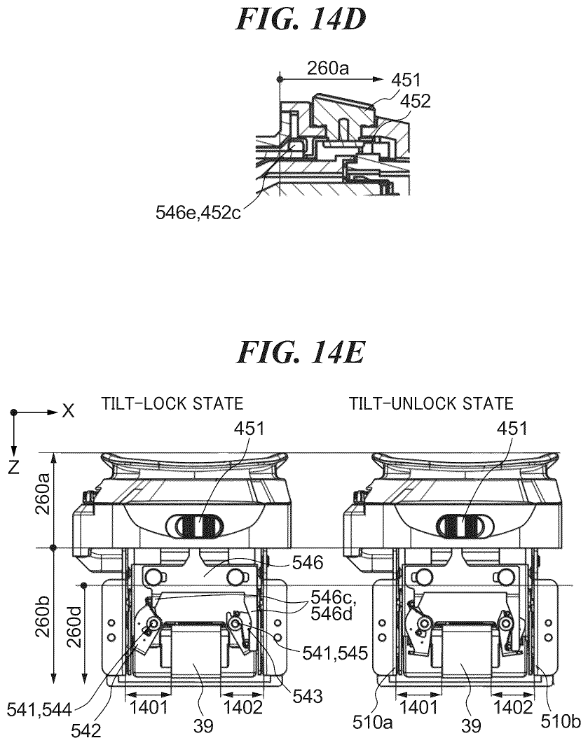

The lock mechanism cover 600 covers the upper surface of the rotation plate 530 of the support mechanism 500 and is fastened to the finder 120 by screws 500b and 500c. The screws 500c are fastened to the finder 120 through the lock mechanism cover 600, a first plane part 530a and a second plane part 530b of the rotation plate 530. With such a configuration, the tilt axis TA of the support mechanism 500 is positioned on the +Y side with respect to an optical axis F (see FIG. 14A) of the finder 120.

The outer cover 450 of the finder 120 is an exterior component that covers the optical unit 12a (see FIG. 4A). The lock lever 451 (a lock operation member) slidable in the X direction is provided on the upper surface of the outer cover 450. When the user operates the lock lever 451, the lock mechanism 540 functions to restrict the tilt operation of the finder 120. The lock lever 451 does not enter the inside of the camera body 1 even when the finder 120 is in the housed state, and therefore, the size up of the camera can be suppressed. The lock mechanism cover 600 is a cover member that covers the upper surface and the side surface of the lock mechanism 540, and is fastened to the inner cover 46 (see FIG. 4A) constituting the finder 120 by the screws 500b and 500c.

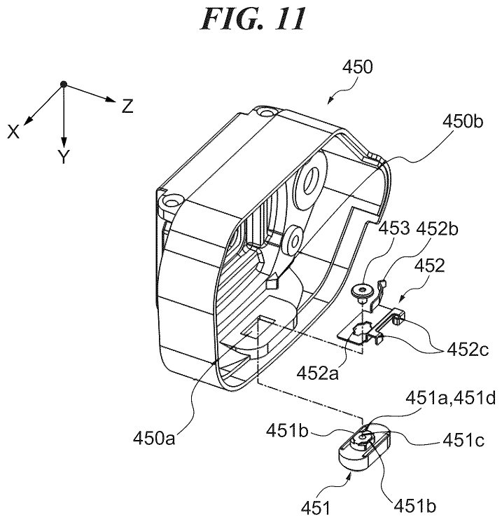

FIG. 11 is an exploded perspective view for explaining the configuration of the lock lever 451. As shown in FIG. 11, the lock lever 451 and a lock lever fixed plate 452 are integrally slidable in the X direction in the outer cover 450.

A boss 451a is formed on the −Y side surface of the lock lever 451. The boss 451a is provided with a pair of sliding surfaces 451b arranged opposite to each other in the Z direction to sandwich its center. In addition, the boss 451a is provided with a prepared hole 451c into which a screw 453 is inserted at the center of the −Y side surface. Further, the boss 451a is provided with a fitting stepped part 451d fitted to the lock lever fixed plate 452 at the distal end portion thereof.

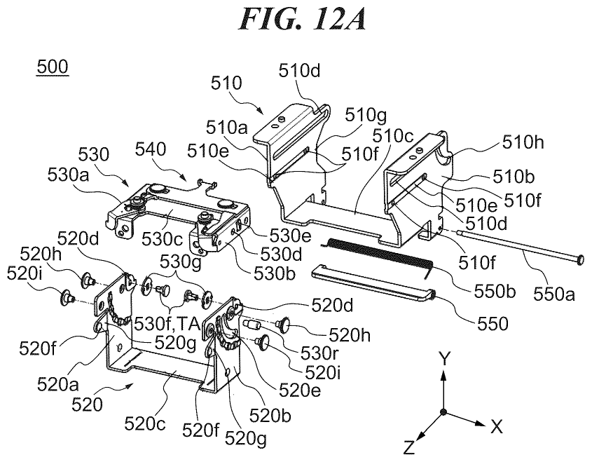

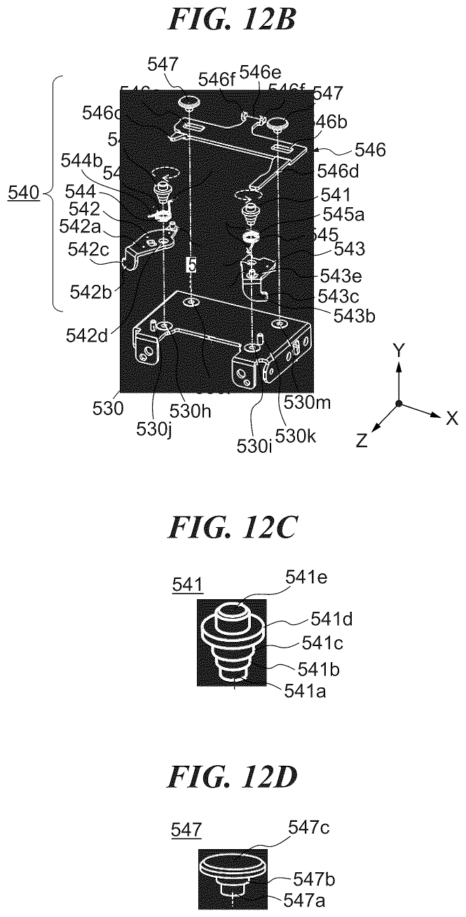

The lock lever fixed plate 452 is provided with a hole 452a, a biasing part 452b, and a pair of arms 452c. The fitting stepped part 451d of the lock lever 451 is fitted into the hole 452a. The biasing part 452b gives a click feeling to the user when the lock lever 451 is operated. The pair of arms 452c are arranged so as to sandwich a coupling plate 546 (see in FIG. 12B) of the lock mechanism 540.

The outer cover 450 is provided with a through hole 450a and a convex part 450b. A boss 451a extending from the −Y side surface of the lock lever 451 is inserted into the through hole 450a. When the finder 120 is transitioned between the tilt-lock state and the tilt-unlock state by the operation of the lock lever 451, the tip of the biasing part 452b gets over the convex part 450b.

FIGS. 12A and 12B are an exploded perspective view of the support mechanism 500 and an exploded perspective view of the lock mechanism 540. Further, FIG. 12C and FIG. 12D are perspective views of a rotation shaft 541 and a rectilinear shaft 547. The support mechanism 500 and the lock mechanism 540 will be described below with reference to FIGS. 12A to 12D. In the following description, the rotation in the tilt direction is referred to as tilt rotation.

The support mechanism 500 is provided in the camera body 1 and supports the finder 120 so as to allow transition between a plurality of states. That is, the support mechanism 500 supports the finder 120 so as to be slid and pulled out from the housed state, and supports so as to be tilted and rotated from the pulled-out state. The lock mechanism 540 restricts the tilt rotation. The support mechanism 500 includes a fixed plate 510, a rectilinear plate 520, a rotation plate 530, the lock mechanism 540, and a flip member 550.

The fixed plate 510 is a component that is manufactured by pressing a metal plate and serves as a structural skeleton of the support mechanism 500. The fixed plate 510 is fixed to the camera body 1. The fixed plate 510 has a first plane part 510a and a second plane part 510b. The first plane part 510a and the second plane part 510b are substantially parallel to the Z direction and substantially orthogonal to the X direction, and are opposed to each other in the axial direction of the tilt axis TA. The first plane part 510a and the second plane part 510b are located on the −Y side than the finder lens center F (see FIG. 4D) and are connected to a third plane part 510c that is substantially parallel to the X direction and the Z direction. Thus, the fixed plate 510 is formed in a substantially U-shape.

In a state where the upper surface cover unit 22 (see FIGS. 3A and 3B) and the finder unit 260 are fastened to each other, the fixed plate 510 is fastened to the accessory shoe holding member 33 with screws 26a (see FIG. 10). Therefore, the fixed plate 510 and the accessory shoe holding member 33 form a substantially O-shape (rectangular tube shape), and thus the rigidity is increased.

Each of the first plane part 510a and the second plane part 510b is provided with a linear rail 510d extending linearly in the rectilinear direction (Z direction) of the rectilinear plate 520. Further, a concave part 510e extending linearly in the rectilinear direction (Z direction) is formed in each of the first plane part 510a and the second plane part 510b, and click holes 510f are formed at both ends of the concave part 510e. The first plane part 510a is disposed on the side of the diopter adjustment dial 17 (see FIG. 1) in the X direction with respect to the finder lens center F, and the second plane part 510b is disposed on the side opposite to the diopter adjustment dial 17 in the X direction with respect to the finder lens center F.

A cutout shape 510g is formed at a −Z side end of the first plane part 510a. When the finder 120 is in the housed state, the cutout shape 510g is used as a space for housing the diopter adjustment dial 17. In the second plane part 510b, an arc-shaped rail 510h that branches in an arc shape to the −Y side in the middle of the linear rail 510d is formed continuously with the linear rail 510d. That is, the arc-shaped rail 510h extends in the arc shape from the middle of the linear rail 510d along the circumferential direction of a circle centered on the tilt axis TA (see FIG. 10) of the rotation plate 530.

The rectilinear plate 520 is a component that is manufactured by pressing a metal plate and is disposed inside the fixed plate 510. The rectilinear plate 520 is held by the fixed plate 510 so as to be linearly movable only in the Z direction relative to the fixed plate 510.

The rectilinear plate 520 has a first plane part 520a and a second plane part 520b. The first plane part 520a and the second plane part 520b are substantially parallel to the Z direction, substantially orthogonal to the X direction, and opposed to each other in the axial direction of the tilt axis TA. The first plane part 520a and the second plane part 520b are located on the −Y side than the finder lens center F and are connected to a third plane part 520c that is substantially parallel to the X direction and the Z direction. Thus, the rectilinear plate 520 is formed in a substantially U-shape.

The first plane part 520a is disposed on the side of the diopter adjustment dial 17 in the X direction with respect to the finder lens center F, and the second plane part 520b is disposed on the side opposite to the diopter adjustment dial 17 in the X direction with respect to the finder lens center F. A hole 520d is provided in each of the first plane part 520a and the second plane part 520b. The hole 520d is a bearing of a rotation shaft pin 530f that is the tilt axis TA of the rotation plate 530. An arc-shaped rail 520e is formed in the second plane part 520b at a position corresponding to the arc-shaped rail 510h of the fixed plate 510.

A plate spring part 520g protrudes from each of the first plane part 520a and the second plane part 520b to the +Z side. A convex part 520f provided at the tip end of the plate spring part 520g is elastically engaged with the concave part 510e and the click holes 510f of the fixed plate 510.

The first plane part 520a and the second plane part 520b are each provided with a pair of linear guide shafts 520h and 520i. The linear guide shafts 520h and 520i are inserted through the linear rails 510d and one pair is caulked to the first plane part 520a of the rectilinear plate 520 and the other pair is caulked to the second plane part 520b in a state where the rectilinear plate 520 is disposed adjacent to the inner side of the substantially U-shaped fixed plate 510. Thus, the rectilinear plate 520 can move linearly in the Z direction with respect to the fixed plate 510.

The convex parts 520f of the rectilinear plate 520 slides in the concave parts 510e of the fixed plate 510, and thus an operation feeling when the rectilinear plate 520 moves linearly is obtained. That is, when the rectilinear plate 520 moves with respect to the fixed plate 510, a reaction to the movement is generated by friction due to engagement between the concave parts 510e of the fixed plate 510 and the convex parts 520f of the rectilinear plate 520, and the operation feeling is generated. Further, the click-stop feeling when the finder 120 is in the housed state and the pulled-out state is obtained by the engagement between the convex parts 520f of the rectilinear plate 520 and the click holes 510f of the fixed plate 510.

The rotation plate 530 is a component that is manufactured by pressing a metal plate and is disposed inside the rectilinear plate 520. The rotation plate 530 is held by the rectilinear plate 520 so as to be rotatable around the tilt axis TA with respect to the rectilinear plate 520.

The rotation plate 530 has the first plane part 530a and the second plane part 530b. The first plane part 530a and the second plane part 530b are substantially parallel to the Z direction, substantially orthogonal to the X direction, and opposed to each other in the axial direction of the tilt axis TA. The first plane part 530a and the second plane part 530b are located on the +Y side than the finder lens center F and are connected to a third plane part 530c that is substantially parallel to the X direction and the Z direction. Thus, the rotation plate 530 is formed in a substantially U-shape. Further, the plane parts 520a, 520b, and 520c of the rectilinear plate 520 and the plane parts 530a, 530b, and 530c of the rotation plate 530 cooperate to form a substantially O-shape (rectangular tube shape), and thus the rigidity is increased.

Since the first plane part 530a and the second plane part 530b of the rotation plate 530 are disposed in the substantially triangular space 37c (see FIG. 4D) formed in the optical unit 12a, it is possible to suppress the size up of the support mechanism 500 in the X direction due to the assembling of the rotation plate 530 to the rectilinear plate 520. Further, the third plane part 530c of the rotation plate 530 is disposed in the substantially rectangular space 37a (see FIG. 4C) formed in the optical unit 12a, and thus it is possible to suppress the size up of the support mechanism 500 in the Y direction due to the assembling of the rotation plate 530 to the rectilinear plate 520.

A hole 530d that is the center of the tilt axis TA of the rotation plate 530 is provided in each of the first plane part 530b and the second plane part 530d. A stand bent part 530e bent in the axial direction of the tilt axis TA is formed in the vicinity of the hole 530d.

The holes 520d of the rectilinear plate 520 and the holes 530d of the rotation plate 530 are arranged coaxially. The rotation shaft pins 530f are caulked in a state of being inserted through the holes 520d and 530d and disc springs 530g. Thus, the tilt axis TA that is the center of the tilt rotation of the rotation plate 530 is formed.

Each of the disc springs 530g is fixed in a state of being compressed and bent in the axial direction of the tilt axis TA, and thereby applies a rotational torque when the rotation plate 530 is rotated. Thus, the rectilinear plate 520 and the rotation plate 530 are connected to each other so as to be rotatable around the tilt axis TA, and can be held at an arbitrary rotational position.

In the third embodiment, the disc springs 530g are disposed on both of the rotation shaft pins 530f in the X direction, but the disc spring 530g may be disposed on only one side. Further, although the configuration that generates a certain rotational torque within the rotation range of the rotation plate 530 is shown in the third embodiment, a concave part to which the disc spring 530g engages may be provided in the vicinity of the tilt axis TA of the rotation plate 530 so that a click feeling is generated at a certain rotation angle.

The first plane part 530a is disposed on the side of the diopter adjustment dial 17 in the X direction with respect to the finder lens center F, and the second plane part 530b is disposed on the side opposite to the diopter adjustment dial 17 in the X direction with respect to the finder lens center F.

A linear movement restriction shaft 530r is inserted through the linear rail 510d of the fixed plate 510 and the arc-shaped rail 520e of the rectilinear plate 520 and is caulked to the second plane part 530b of the rotation plate 530 in the state where the fixed plate 510, the rectilinear plate 520, and the rotation plate 530 are assembled. Thus, in a process in which the rotation plate 530 rotates, the linear movement restriction shaft 530r engages with the arc-shaped rail 510h of the fixed plate 510, thereby the linear movement of the rectilinear plate 520 can be restricted in the tilt-unlock state.

A flip member 550 is disposed on the −Y side than the third plane part 510c of the fixed plate 510. The flip member 550 is rotatably supported by the fixed plate 510 via a shaft 550a, and is configured to bias the rectilinear plate 520 to the +Y side with a torsion spring 550b. In the support mechanism 500, the fixed plate 510, the rectilinear plate 520, and the rotation plate 530 are arranged in this order from the outside of the camera body 1 toward the finder lens center F in the X direction, and thus it is possible to suppress the size up of the support mechanism 500 without impairing the operation feeling.

The lock mechanism 540 is disposed on the upper surface of the third plane part 520c of the rotation plate 530. The lock mechanism 540 includes rotation shafts 541, lock plates 542 and 543, torsion springs 544 and 545, a coupling plate 546, and the rectilinear shafts 547.

The lock plates 542 and 543 (first and second lock plates) are manufactured by pressing metallic plates, and are components that are rotatably held by the rotation shaft 541 orthogonal to the third plane part 530c of the rotation plate 530. The lock plate 542 has a first plane part 542a and a second plane part 542b, and the lock plate 543 has a first plane part 543a and a second plane part 543b. The first plane parts 542a and 543a are arranged in parallel to the third plane part 530c of the rotation plate 530. The second plane parts 542b and 543b are bent from the first plane part 542a and 543a to the −Y side and are respectively orthogonal to the first plane parts 542a and 543a.

Lock parts 542c and 543c (tips of the first and second lock plates) extending in locking directions RC1 and RC2 are respectively provided at the tips of the second plane parts 542b and 543b. A torsion spring 544 (biasing member) is a component that includes a coil part 544a and hook parts 544b and biases the lock plate 542 in the locking direction RC1. A torsion spring 545 (biasing member) is a component that includes a coil part 545a and hook parts 545b and biases the lock plate 543 in the locking direction RC2.

A caulking part 541a, a rotation plate rotating shaft 541b, a coil attachment part 541c, and a coil retaining part 541d are provided on the rotation shaft 541 in this order from the −Y side, and are formed such that the diameters thereof increase in order from the −Y side. Further, the rotation shaft 541 is provided with a fitting part 541e on the +Y side surface of the coil retaining part 541d. The fitting part 541e is inserted into a hole of the lock mechanism cover 600 (see FIG. 10).

One of the rotation shafts 541 is caulked to the rotation plate 530 in a state of being inserted through a coil part 544a of the torsion spring 544, a hole 542d serving as the rotation center of the lock plate 542, and a hole 530h of the rotation plate 530. The other of the rotation shafts 541 is caulked to the rotation plate 530 in a state of being inserted through the coil part 545a of the torsion spring 545, a hole 543d serving as the rotation center of the lock plate 543, and a hole 530i of the rotation plate 530. Thus, the lock plates 542 and 543 are rotatably slide-fitted to the rotation plate rotating shafts 541b of the rotation shafts 541, and are prevented from being detached in the axial direction of the rotation shafts 541 by the coil attachment parts 541c formed adjacent to the rotation plate rotating shafts 541b on the +Y side.

In addition, the coil parts 544a and 545a of the torsion springs 544 and 545 are respectively axially supported by the coil attachment parts 541c of the rotation shafts 541, and are prevented from being detached in the axial direction of the rotation shafts 541 by the coil retaining parts 541d that are formed adjacent to the coil attachment parts 541c on the +Y side. In the rotation shaft 541, the caulking part 541a on the tip of the −Y side is axially supported by the rotation plate 530, and the fitting part 541e on the tip of the +Y side is axially supported by the lock mechanism cover 600. Therefore, even when a force acts on the lock plates 542 and 543, the rotation shafts 541 are not easily inclined.

The hook parts 544b of the torsion spring 544 are respectively hooked on a fixed-side pin 530j caulked to the rotation plate 530 and a movable-side pin 542e caulked to the lock plate 542. And the hook parts 545b of the torsion spring 545 are respectively hooked on a fixed-side pin 530k caulked to the rotation plate 530 and a movable-side pin 543e caulked to the lock plate 543. As a result, the lock plate 542 is biased in the locking direction RC1 (clockwise), and the lock plate 543 is biased in the locking direction RC2 (counterclockwise).

The coupling plate 546 is a component that is manufactured by pressing a metal plate, is disposed on the surface on the +Y side than the third plane part 530c of the rotation plate 530, and is held so as to be movable (linearly movable) in parallel in the X direction with respect to the third plane part 530c of the rotation plate 530. Each of the rectilinear shafts 547 is provided with a caulking part 547a, a linear movement restriction part 547b, and a coupling plate retaining part 547c in this order from the −Y side, and the diameters of these parts are formed so as to increase in order from the −Y side.

One of the rectilinear shafts 547 is caulked to the rotation plate 530 in a state of being inserted through a hole 546a of the coupling plate 546 and a hole 530l of the rotation plate 530. And the other of the rectilinear shafts 547 is caulked to the rotation plate 530 in a state of being inserted through a hole 546b of the coupling plate 546 and the hole 530m of the rotation plate 530. Thus, the coupling plate 546 is slidably fitted to the linear movement restriction part 547b of the rectilinear shaft 547 so as to be movable in the X direction, and is prevented from being detached in the axial direction of the rectilinear shaft 547 by the coupling plate retaining part 547c formed adjacent to the linear movement restriction part 547b on the +Y side.

The coupling plate 546 is provided with an extension part 546c abutting on the movable-side pin 542e caulked to the lock plate 542 and an extension part 546d abutting on the movable-side pin 543e caulked to the lock plate 543. Since the extension part 546c of the coupling plate 546 abuts on the movable-side pin 542e on the −Z side than the hole 542d that is the rotation center of the lock plate 542, the coupling plate 546 is biased to the +X side by the torsion spring 544. Further, since the extension part 546d of the coupling plate abuts on the movable-side pin 543e on the +Z side than the hole 543d that is the rotation center of the lock plate 543, the coupling plate 546 is similarly biased to the +X side by the torsion spring 545.

The coupling plate 546 is provided with a grip part 546e. The grip part 546e is gripped between the pair of arms 452c (see FIG. 11) of the lock lever fixed plate 452 attached to the outer cover 450. Since the coupling plate 546 is a pressed part having a thin plate thickness, the grip part 546e is provided with stand bent parts 546f orthogonal to the sliding direction (X direction) of the lock lever 451. In this way, the abutting area between the pair of arms 452c of the lock lever fixed plate 452 and the grip part 546e of the coupling plate 546 can be sufficiently secured.

With such a configuration, in the lock mechanism 540, when the lock lever 451 slides from one side to the other side opposite thereto in the sliding direction (X direction), the coupling plate 546 moves to the −X side while resisting the force of the torsion springs 544 and 545. Therefore, the lock plate 542 moves in the direction (counterclockwise) opposite to the locking direction RC1, and the lock plate 543 moves in a direction (clockwise) opposite to the locking direction RC2. That is, when the third plane part 530c of the rotation plate 530 is viewed from the +Y side, the lock part 542c of the lock plate 542 and the lock part 543c of the lock plate 543 perform approaching movement in the axial direction (X direction) of the tilt axis TA.

In contrast, when the lock lever 451 slides from the other side to the one side in the sliding direction (X direction), the coupling plate 546 moves to the +X side due to the biasing force of the torsion springs 544 and 545. Therefore, the lock plate 542 moves in the locking direction RC1 (clockwise), and the lock plate 543 moves in the locking direction RC2 (counterclockwise). That is, when the third plane part 530c of the rotation plate 530 is viewed from the +Y side, the lock part 542c of the lock plate 542 and the lock part 543c of the lock plate 543 perform separation movement in the axial direction (X direction) of the tilt axis TA. Therefore, the torsion springs 544 and 545 bias the lock part 542c of the lock plate 542 and the lock part 543c of the lock plate 543 to move away from each other, and the coupling plate 546 biases the lock parts 542c and 543c to move away from each other by the urging force acting through the lock parts 542c and 543c.

The coupling plate 546 interlocks the operation of the lock lever 451 with the separation movement and the approaching movement of the lock part 542c of the lock plate 542 and the lock part 543c of the lock plate 543. The lock lever 451 operates the separation movement and the approaching movement of the lock part 542c of the lock plate 542 and the lock part 543c of the lock plate 543.

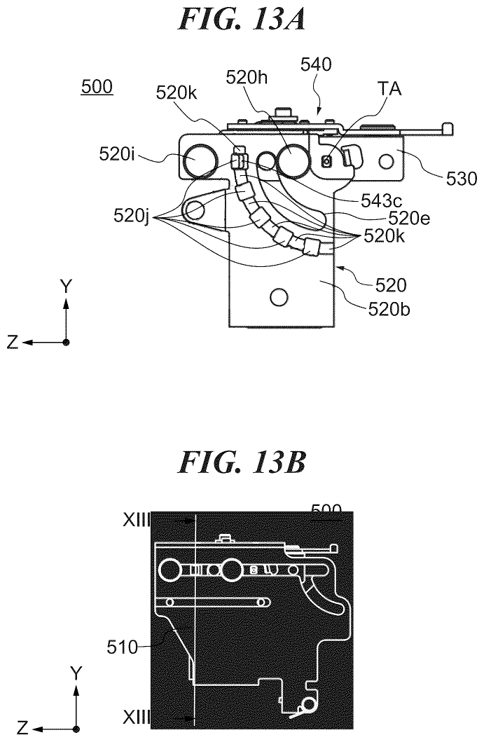

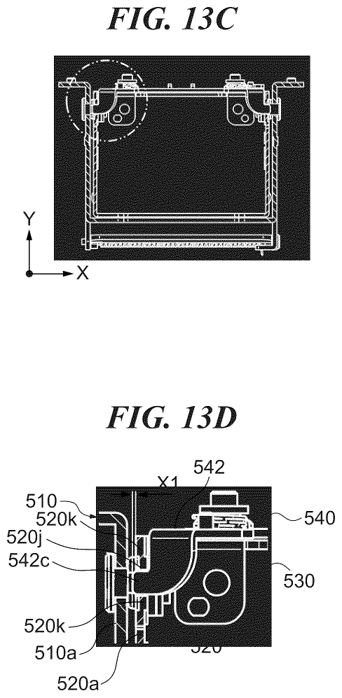

FIGS. 13A to 13D are views for explaining a configuration for locking the finder 120. FIG. 13A is a side view of the support mechanism 500 viewed from the +X side, in which the fixed plate 510 and the flip member 550 are not shown. FIG. 13B is a side view showing a part of the support mechanism 500 where the lock plate 542 is locked to the rectilinear plate 520, FIG. 13C is a sectional view obtained by cutting the structure shown in FIG. 13B at a position of XIIIC-XIIIC, and FIG. 13D is a partially enlarged view of a part C in FIG. 13C.

Each of the first plane part 520a and the second plane part 520b of the rectilinear plate 520 is formed with five lock holes 520j. In the rectilinear plate 520, each lock hole 520j (first lock hole) of the first plane part 520a and each lock hole 520j (second lock hole) of the second plane part 520b are in a positional relationship of facing each other in the axial direction of the tilt axis TA. In each of the first plane part 520a and the second plane part 520b, the five lock holes 520j are arranged at a predetermined pitch on an arc centered on the tilt axis TA on the −Z side of the arc-shaped rail 520e and on the +Z side of the linear guide shaft 520i.

The rotation operation of the rotation plate 530 can be regulated by fitting the lock part 542c of the lock plate 542 of the lock mechanism 540 configured on the +Y side of the rotation plate 530 into any one of the five lock holes 520j on the first plane part 520a and fitting the lock part 543c of the lock plate 543 into any one of the five lock holes 520j on the second plane part 520b. That is, in the state where the rotation plate 530 is rotated, when the lock part 542c of the lock plate 542 enters any one of the five lock holes 520j on the first plane part 520a and the lock part 543c of the lock plate 543 enters any one of the five lock holes 520j on the second plane part 520b due to the separation movement of the lock part 542c of the lock plate 542 and the lock part 543c of the lock plate 543, the finder 120 transitions to the tilt lock state.

Further, when the lock part 542c of the lock plate 542 deviates from any of the five lock holes 520j on the first plane part 520a and the lock part 543c of the lock plate 543 deviates from any of the five lock holes 520j on the second plane part 520b due to the approaching movement of the lock part 542c of the lock plate 542 and the lock part 543c of the lock plate 543, the finder 120 transitions to the tilt-unlock state.

As described above, the torsion springs 544 and 545 bias the lock part 542c of the lock plate 542 and the lock part 543c of the lock plate 543 to move away from each other. Therefore, the torsion spring 544 biases the lock part 542c of the lock plate 542 to a side of entering any one of the five lock holes 520j of the first plane part 520a, and the torsion spring 545 biases the lock part 543c of the lock plate 543 to a side of entering any one of the five lock holes 520j of the second plane part 520b.

In this way, the support mechanism 500 constitutes the lock mechanism 540 that can fix the finder 120 at a predetermined tilt angle while ensuring a large tilt angle of the finder 120. In addition, in each of the first plane part 520a and the second plane part 520b of the rectilinear plate 520, the finder 120 can be fixed at a plurality of tilt angles with the five lock holes 520j.

Although the five lock holes 520j are provided at an equal pitch in each of the first plane part 520a and the second plane part 520b of the rectilinear plate 520, the lock holes 520j may be provided at unequal pitches. A chamfered shape (not shown) for smoothly fitting into the lock holes 520j is provided at each of the tip of the lock part 542c of the lock plate 542 and the tip of the lock part 543c of the lock plate 543.

When the lock part 542c of the lock plate 542 and the lock part 543c of the lock plate 543 are intended to sufficiently secure the engagement amount with the lock holes 520j, a protrusion amount X1 from the first plane part 520a and the second plane part 520b of the rectilinear plate 520 increases. When the protrusion amount X1 is large, the fixed plate 510 is increased in size because it is necessary to secure a clearance between the lock part 542c of the lock plate 542 and the first plane part 510a of the fixed plate 510 and a clearance between the lock part 543c of the lock plate 543 and the second plane part 510b of the fixed plate 510.

Therefore, in each of the first plane part 520a and the second plane part 520b of the rectilinear plate 520, stepped parts 520k are provided on both sides of each lock hole 520j in the circumferential direction of the circle centered on the tilt axis TA. As shown in the partially enlarged view in FIG. 13D, the stepped parts 520k of the first plane part 510a are formed by a half-blanking press process so that the first plane part 520a of the rectilinear plate 520 protrudes toward the opposite side in the X direction (axial direction of the tilt axis TA). And the stepped parts 520k of the second plane part 520b are similarly formed by the half-blanking press process so that the first plane part 520a and the second plane part 520b of the rectilinear plate 520 protrude toward the opposite side in the X direction (axial direction of the tilt axis TA). Thus, the protrusion amount X1 from the first plane part 520a and the second plane part 520b of the rectilinear plate 520 can be minimized while sufficiently ensuring the engagement amounts of the lock part 542c of the lock plate 542 and the lock part 543c of the lock plate 543 with the lock holes 520j.

FIGS. 14A to 14E are views for explaining the arrangement of components of the lock mechanism 540 of the finder unit 260. FIG. 14A is a top view of the finder unit 260, FIG. 14B is a sectional view obtained by cutting the finder unit 260 at a position of XIVB-XIVB in FIG. 14A, and FIG. 14C is a sectional view obtained by cutting the finder unit 260 at a position of XIVC-XIVC in FIG. 14A. FIG. 14D is a partially enlarged view of a part E in FIG. 14B.

An area of the finder unit 260 that is a part of an appearance area (an area exposed to outside) of the camera in the housed state of the finder 120 is referred to as a housed-state appearance area 260a (an external area), and an area of the finder unit 260 housed in the camera body 1 in the housed state is referred to as a housed area 260b. In the finder unit 260, a region in which the lens holder 36 (see FIGS. 4A to 4D) can move is referred to as a lens part region 260c, and a region on the +Z side of the lens part region 260c is referred to as a display panel region 260d (a region to which the lens cannot enter). Further, in the finder unit 260, a height region used when the finder flexible substrate 39 is wired to the main board 24 (see FIG. 3A) is referred to as a wire height region 260e.

As shown in FIG. 14B that is the partially enlarged view of the part E in FIG. 14D, the lock lever 451 is positioned on the +Y side than the optical axis F of the lens group 36a of the finder 120 (i.e., the lock lever 451 is disposed above the optical axis). This is because it is necessary to correspond to the tilt axis TA located on the +Y side than the optical axis F of the lens group 36a of the finder 120, similarly. Since the lock lever 451 is disposed in the housed-state appearance area 260a, it does not enter the camera body 1 when the finder 120 is in the housed state.

Further, since the grip part 546e of the coupling plate 546 and the pair of arms 452c of the lock lever fixed plate 452 are coupled to each other within the housed-state appearance area 260a, they do not enter the inside of the camera body 1 when the finder 120 is in the housed state. With these configurations, it is possible to suppress the size up of the camera.

FIG. 14E is a plan view of the finder unit 260 viewed from the +Y side while hiding the lock mechanism cover 600, and is a view showing a case where the finder 120 is in the tilt lock state and a case where the finder 120 is in the tilt-unlock state.

The rotation shaft 541, the lock plates 542 and 543, the torsion springs 544 and 545, and the extension parts 546c and 546d of the coupling plate 546, which constitute the lock mechanism 540, are disposed within the display panel region 260d in the Z direction. Therefore, the lock holes 520j formed in the first plane part 520a and the second plane part 520b of the rectilinear plate 520 are arranged in the display panel region 260d when viewed from the Z direction (the axial direction of the tilt axis TA).

Further, the rotation shaft 541, the lock plate 542, the torsion spring 544, and the extension part 546c of the coupling plate 546, which constitute the lock mechanism 540 are disposed in a space 1401 between the finder flexible substrate 39 and the first plane part 510a of the fixed plate 510. In addition, the rotation shaft 541, the lock plate 543, the torsion spring 545, and the extension part 546d of the coupling plate 546, which constitute the lock mechanism 540, are disposed in a space 1402 between the finder flexible substrate 39 and the second plane part 510b of the fixed plate 510.

With these arrangements, the lock plates 542, 543 constituting the lock mechanism 540 are arranged on the −Y side than the wire height region 260e as shown in FIG. 14C that is the XIVC-XIVC sectional view of the finder unit 260 in FIG. 14A. This enables to suppress the size up of the finder unit 260 in the Y direction.

As described above, the camera related to the third embodiment can rotate the finder 120 pulled out from the camera body 1 and lock the finder 120 at the rotated position by using the support mechanism 500 built in the main body of the electronic apparatus.

Although the preferred embodiments of the present invention have been described above, the present invention is not limited to the above-described embodiments, and various modifications and changes can be made within the scope of the gist of the present invention.

For example, the tilt rail 51e of the first embodiment may be formed in the arc-shape similar to the tilt rail 51n of the second embodiment. That is, the tilt rail 51e of the first embodiment may have a shape in which the length to the center of the rotation shaft pin 57 (the tilt axis TA) when the finder 12 is in the pulled-out state decreases toward the tip at which the key groove 51i is provided. The tilt rails 51e and 52e of the first embodiment may be formed only in one sides that are the first plane parts 51a and 52a of the fixed plate 51 and the rectilinear plate 52 or may be formed only in the other sides that are the second plane parts 51b and 52b of the fixed plate 51 and the rectilinear plate 52.

In the second embodiment, a plurality of key grooves 51p may extend from the tilt rail 51n. In such a case, the intervals of the key grooves 51p may be equal or may be arbitrary. The tilt rails 51n and 52e of the second embodiment may be formed only in the first plane parts 51a and 52a of the fixed plate 51 and the rectilinear plate 52, or may be formed only in the second plane parts 51b and 52b of the fixed plate 51 and the rectilinear plate 52.

In the third embodiment, the five lock holes 520j provided in each of the first plane part 520a and the second plane part 520b of the rectilinear plate 520 allow for locking at multiple tilt angles. Therefore, if it is not necessary to hold the tilt angle at an arbitrary tilt angle, the disc springs 530g may be omitted.

In the first embodiment, many key grooves may be formed to be extended from the tilt rail 51e of the fixed plate 51 to enable locking of the tilt angle as with a near stepless configuration. This point is the same for the second and the third embodiments.

According to the present invention, the finder pulled out from the electronic apparatus body can be rotated and locked at the rotated position by using the support mechanism incorporated in the electronic apparatus body.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electronic apparatus comprising:
an apparatus body;
a finder having a lens; and
a support mechanism provided in the apparatus body, supporting the finder so as to transition between a plurality of states, and having a rotation shaft serving as a rotation center of the finder,
wherein the plurality of states include a housed state in which the finder is housed in the apparatus body, a pulled-out state in which the finder is pulled out from the apparatus body, a rotatable state in which the finder can be rotated from the pulled-out state, and a tilt-lock state in which the finder is locked at a tilted position from the pulled-out state, and
wherein the rotation shaft is located outside the apparatus body in a case where the finder is in any of the pulled-out state, the rotatable state, and the tilt-lock state, and moves from the outside of the apparatus body into the apparatus body as the finder transitions to the housed state.

2. The electronic apparatus according to claim 1, wherein the support mechanism comprises:
a fixed plate that is fixed to the apparatus body;
a rectilinear plate that is held by the fixed plate so as to be linearly movable with respect to the fixed plate; and
a rotation plate that is rotatable around the rotation shaft with respect to the rectilinear plate,
wherein each of the fixed plate, the rectilinear plate, and the rotation plate includes a first plane part and a second plane part that face each other in an axial direction of the rotation shaft, and
wherein the first plane part and the second plane part of the rectilinear plate are arranged between the first plane part and the second plane part of the fixed plate, and the first plane part and the second plane part of the rotation plate are arranged between the first plane part and the second plane part of the rectilinear plate.

3. The electronic apparatus according to claim 2, wherein the support mechanism comprises:
an outer arc-shaped rail provided in each of the first plane part and the second plane part of the fixed plate;
a key groove provided in each of the first plane part and the second plane part of the fixed plate so as to be extended from the outer arc-shaped rail;
an inner arc-shaped rail provided in each of the first plane part and the second plane part of the rectilinear plate so as to be arranged at a position surround the outer arc-shaped rail and the key groove in a case where the finder is in the pulled-out state, the rotatable state, and the tilt-lock state;
a rectilinear tilt plate to which the finder is fixed, that is rotatable together with the rotation plate with respect to the rectilinear plate through the rotation shaft and is held by the rotation plate so as to be linearly movable with respect to the rotation plate;
a key shaft that is connected to the rectilinear tilt plate, that moves in the outer arc-shaped rail of the fixed plate and the inner arc-shaped rail of the rectilinear plate during rotations of the rectilinear tilt plate and the rectilinear plate,
wherein the finder transitions to the tilt-lock state when the key shaft enters the key groove in conjunction with linear movement of the rectilinear tilt plate to one side in a state where the rectilinear tilt plate and the rectilinear plate are rotated, and
wherein the finder transitions to the rotatable state when the key shaft the key shaft deviates from the key groove in conjunction with linear movement of the rectilinear plate to a side opposite to the one side.

4. The electronic apparatus according to claim 3, wherein a plurality of the key grooves are provided in each of the first plane part and the second plane part of the fixed plate.

5. The electronic apparatus according to claim 3, further comprising:
a first linear rail that is provided on each of the first plane part and the second plane part of the fixed plate along a direction orthogonal to an axial direction of the rotation shaft so as to be extended from the outer arc-shaped rail at one end in a direction of pulling out the finder, in which the key shaft moves during linear movement of the rectilinear plate;
a second linear rail that is proved on each of the first plane part and the second plane part of the fixed plate in parallel to the first linear rail; and
a linear guide shaft that is connected to the rectilinear plate and moves in the second linear rail of the fixed plate during linear movement of the rectilinear plate,
wherein the finder transitions to the pulled-out state when the linear guide shaft abuts against one end of the second linear rail and the key shaft remains in the first linear rail in a state where the rectilinear plate is moving linearly in conjunction with a pulling operation of the finder.

6. The electronic apparatus according to claim 5, wherein the finder becomes rotatable when the rectilinear tilt plate moves linearly in conjunction with the pulling operation of the finder and the key shaft moves to one end of the first linear rail extended from the outer arc-shaped rail in a case where the finder is in the pulled-out state.

7. The electronic apparatus according to claim 3, further comprising:
a first linear rail that is provided on each of the first plane part and the second plane part of the fixed plate along a direction orthogonal to an axial direction of the rotation shaft so as to be extended from the outer arc-shaped rail at one end in a direction of pulling out the finder, in which the key shaft moves during linear movement of the rectilinear plate;
a second linear rail that is proved on each of the first plane part and the second plane part of the fixed plate in parallel to the first linear rail; and
a linear guide shaft that is connected to the rectilinear plate and moves in the second linear rail of the fixed plate during linear movement of the rectilinear plate,
wherein the finder transitions to the pulled-out state and the finder becomes rotatable when the linear guide shaft abuts against one end of the second linear rail and the key shaft moves to one end of the first linear rail extended from the outer arc-shaped rail in a state where the rectilinear plate is moving linearly in conjunction with a pulling operation of the finder.

8. The electronic apparatus according to claim 3, wherein the support mechanism is provided with a biasing part that applies a biasing force in a pull-out/housing direction of the finder to the rectilinear tilt plate.

9. The electronic apparatus according to claim 8, wherein the biasing force of the biasing part biases the rectilinear tilt plate in a direction opposite to a direction of pulling the finder from the apparatus body.

10. The electronic apparatus according to claim 9, wherein the biasing force of the biasing part generates or changes a force required for operating the finder when the finder transitions from the pulled-out state to the rotatable state and generates or changes a force required for operating the finder when the finder transitions to the tilt-lock state to the rotatable state.

11. The electronic apparatus according to claim 10, wherein the support mechanism comprises:
an engaged part that is proved on each of the first plane part and the second plane part of the fixed plate; and
an engaging part that is provided on each of the first plane part and the second plane part of the rectilinear plate and corresponds to the engaged part on each of the first plane part and the second plane part of the fixed plate,
wherein the force required for operating the finder when the finder transitions between the housed state and the pulled-out state is generated of changed by a friction force generated when the rectilinear plate movies linearly while engaging the engaging part elastically with the engaged part of the fixed plate.

12. The electronic apparatus according to claim 11, wherein the biasing force of the biasing pat is larger than the friction force.

13. The electronic apparatus according to claim 8, wherein the finder is provided with a flexible substrate to control a display content of the finder, and
wherein the biasing part comprises tension springs that are hooked to the rectilinear tilt plate and the rotation plate and are arranged in a space between the first plane part of the fixed plate and the flexible substrate and a space between the second plane part and the flexible substrate.

14. The electronic apparatus according to claim 3, wherein a distance from the rotation axis to the outer arc-shaped rail varies depending on a position on the outer arc-shaped rail.

15. The electronic apparatus according to claim 2, wherein the rotation plate comprises:
a third plane part that connects the first plane part and the second plane part of the rotation plate; and
an orthogonal plane part to which the finder is fixed and is orthogonal to a pull-out/housing direction of the finder,
wherein the support mechanism comprises:
a first lock hole that is formed in the first plane part of the rectilinear plate on a circle centered on the rotation shaft;
a second lock hole that is formed in the second plane part of the rectilinear plate at a position facing the first lock hole in an axial direction of the rotation shaft; and
a first lock plate and a second lock plate that are rotatably supported by the third plane part so as to enable separation movement and approaching movement of tips thereof,
wherein the finder transitions to the tilt-lock state when the tip of the first lock plate and the tip of the second lock plate enter the first lock hole and the second lock hole due to the separation movement of the first lock plate and the second lock plate, and
wherein the finder transitions to the rotatable state when the tip of the first lock plate and the tip of the second lock plate deviate from the first lock hole and the second lock hole due to the approaching movement of the first lock plate and the second lock plate.

16. The electronic apparatus according to claim 15, further comprising a lock operation member that operates the separation movement and the approaching movement of the first lock plate and the second lock plate,
wherein the lock operation member is disposed in an appearance area of the finder that is positioned outside the apparatus body when the finder is in the housed state.

17. The electronic apparatus according to claim 16, wherein the lock operation member is positioned above an optical axis of the lens when the finder is in the housed state or the pulled-out state.

18. The electronic apparatus according to claim 16, wherein the support mechanism comprises:
a biasing member that biases the first lock plate and the second lock plate in the direction of the separation movement on the third plane part of the rotation plate; and
a coupling plate that interlocks an operation of the lock operation member with the separation movement and the approaching movement of the first lock plate and the second lock plate,
wherein the coupling plate is held on the third plane part of the rotation plate so as to be linearly movable in the axial direction of the rotation shaft and is biased by a basing force of the biasing member applied through the first lock plate and the second lock plate in the direction of the separation movement of the first lock plate and the second lock plate.

19. The electronic apparatus according to claim 15, wherein the support mechanism comprises a biasing member that biases the first lock plate and the second lock plate in the direction of the separation movement on the third plane part of the rotation plate.

20. The electronic apparatus according to claim 15, wherein a plurality of first lock holes are formed in the first plane part of the rectilinear plate and arranged along a circumferential direction of the circle, and a plurality of second lock holes are formed in the second plane part of the rectilinear plate and arranged along a circumferential direction of a circle around the rotation shaft.

21. The electronic apparatus according to claim 15, wherein the support mechanism includes first stepped parts provided on both sides of the first lock hole in a circumferential direction of the circle in the first plane part of the rectilinear plate, and includes second stepped parts provided at positions corresponding to both sides in the circumferential direction of the circle in the second plane part of the rectilinear plate, and
wherein the first stepped parts and the second stepped parts protrude toward mutually facing sides of the first plane part and the second plane part of the rectilinear plate in the axial direction of the rotation shaft.

22. The electronic apparatus according to claim 15, wherein the finder is provided with a flexible substrate used for controlling a display content of the finder, and
wherein the first lock plate is arranged in a space between the first plane part of the rotation plate and the flexible substrate, and the second lock plate is arranged in a space between the second plane part of the rotation plate and the flexible substrate.

23. The electronic apparatus according to claim 15, wherein the first lock hole and the second lock hole formed in the rectilinear plate are positioned in a region to which the lens cannot enter within a region of the finder fixed to the rotation plate when viewed from the axial direction of the rotation shaft in the support mechanism.
